(19) United States
(12) Patent Application Publication
(10) Pub. No.: US 2009/0026922 A1
(43) Pub. Date: Jan. 29, 2009

(54) Light emitting element, light emitting device, and electronic device

(75) Inventors: Yuji Iwaki, Kanagawa (JP); Satoshi Seo, Kanagawa (JP); Takahiro Kawakami, Kanagawa (JP); Hisao Ikeda, Kanagawa (JP); Junichiro Sakata, Kanagawa (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi, Kanagawa-ken (JP)

(21) Appl. No.: 11/918,569

(22) PCT Filed: Apr. 17, 2006
(86) PCT No.: PCT/JP2006/308481

§ 371 Date: Oct. 16, 2007

(30) Foreign Application Priority Data
Apr. 21, 2005 (JP) 2005-124296

(51) Int. Cl. H01J 63/04

(52) U.S. Cl. 313/504

(57) ABSTRACT

One aspect of the present invention is a light emitting element having a layer including an aromatic hydrocarbon and a metal oxide between a pair of electrodes. The kind of aromatic hydrocarbon is not particularly limited; however, an aromatic hydrocarbon having hole mobility of 1×10⁻⁶ cm²/Vs or more is preferable. As such aromatic hydrocarbon, for example, 2-tert-butyl-9,10-di(2-naphthyl)anthracene, anthracene, 9,10-diphenylanthracene, tetracene, rubrene, perylene, 2,5,8,11-tetra(tert-butyl)perylene, and the like are given. As the metal oxide, a metal which shows an electron-accepting property to the aromatic hydrocarbon is preferable. As such metal oxide, for example, molybdenum oxide, vanadium oxide, ruthenium oxide, rhenium oxide, and the like are given.

### TECHNICAL FIELD

The present invention relates to a light emitting element having a layer including a light emitting substance between electrodes, a light emitting device having the light emitting element, and an electronic device.

### BACKGROUND ART

A light emitting element, which has attracted attentions in recent years as a pixel of a display device or a light source of a lighting device, has a light emitting layer between electrodes, and a light emitting substance included in the light emitting layer emits light when a current flows between the electrodes.

In the development area of such a light emitting element, it is one of the important objects to extend the lifetime of a light emitting element. This is because a light emitting element provided for a light emitting device is necessary to be operated favorably for a long period of time in order to use a light emitting device such as a lighting device or a display device for a long period of time in a favorable condition.

As one of techniques for accomplishing the extension of the life of a light emitting element, for example, a technique relating to a light emitting element using molybdenum oxide or the like as an anode mentioned in Patent Document 1 (Patent Document 1: Japanese Patent Laid-Open No. H9-63771) is given.

It is conceivable that the technique mentioned in Patent Document 1 is also effective; however, molybdenum oxide is easily crystallized, and accordingly, there is a problem that an operation failure of a light emitting element due to crystallization occurs easily with the technique mentioned in Patent Document 1. Further, molybdenum oxide has low conductivity; therefore, a current does not flow easily when a layer made of molybdenum oxide is thickened too much.

### DISCLOSURE OF INVENTION

It is an object of the present invention to provide a light emitting element which can reduce an operation failure due to crystallization of a compound included in a layer provided between electrodes.

One aspect of the present invention is a light emitting element having a layer including an aromatic hydrocarbon and a metal oxide between a pair of electrodes. The kind of aromatic hydrocarbon is not particularly limited; however, an aromatic hydrocarbon having hole mobility of 1×10⁻⁶ cm²/Vs or more is preferable. As such aromatic hydrocarbon, for example, 2-tert-butyl-9,10-di(2-naphthyl)anthracene, anthracene, 9,10-diphenylanthracene, tetracene, rubrene, perylene, 2,5,8,11-tetra(tert-butyl)perylene, and the like are given. As metal oxide, a metal oxide which shows an electron-accepting property to the aromatic hydrocarbon is preferable. As such metal oxide, for example, molybdenum oxide, vanadium oxide, ruthenium oxide, rhenium oxide, and the like are given.

One aspect of the present invention is a light emitting element having a light emitting layer between a first electrode and a second electrode, and a layer including an aromatic hydrocarbon and a metal oxide between the light emitting layer and the first electrode. When a voltage is applied to each of the electrodes so that the electric potential of the first electrode gets higher than that of the second electrode, a light emitting substance included in the light emitting layer emits light. The kind of aromatic hydrocarbon is not particularly limited; however, an aromatic hydrocarbon having hole mobility of 1×10⁻⁶ cm²/Vs or more is preferable. As such aromatic hydrocarbon, for example, 2-tert-butyl-9,10-di(2-naphthyl)anthracene, anthracene, 9,10-diphenylanthracene, tetracene, rubrene, perylene, 2,5,8,11-tetra(tert-butyl)perylene, and the like are given. As the metal oxide, a metal oxide which shows an electron-accepting property to the aromatic hydrocarbon is preferable. As such metal oxide, for example, molybdenum oxide, vanadium oxide, ruthenium oxide, rhenium oxide, and the like are given.

One aspect of the present invention is a light emitting element having a light emitting layer, a first mixed layer, and a second mixed layer between a first electrode and a second electrode, wherein a light emitting substance included in the light emitting layer emits light when a voltage is applied to each of the electrodes so that the electric potential of the first electrode gets higher than that of the second electrode. In such a light emitting element, the light emitting layer is provided closer to the first electrode than the first mixed layer, and the second mixed layer is provided closer to the second electrode than the first mixed layer. The first mixed layer is a layer including an electron transporting substance and a substance selected from alkali metal, alkaline earth metal, alkali metal oxide, alkaline earth metal oxide, alkali metal fluoride, and alkaline earth metal fluoride. Here, as alkali metal, lithium (Li), natrium (Na), potassium (K), and the like are given, for example. As alkaline earth metal, magnesium (Mg), calcium (Ca), and the like are given, for example. As alkali metal oxide, lithium oxide (Li₂O), natrium oxide (Na₂O), potassium oxide (K₂O), and the like are given. As alkaline earth metal oxide, magnesium oxide (MgO), calcium oxide (CaO), and the like are given. As alkali metal fluoride, lithium fluoride (LiF), cesium fluoride (CsF), and the like are given. As alkaline earth metal fluoride, magnesium fluoride (MgF₂), calcium fluoride (CaF₂), and the like are given. The second mixed layer is a layer including an aromatic hydrocarbon and a metal oxide. Here, the kind of aromatic hydrocarbon is not particularly limited; however, an aromatic hydrocarbon having hole mobility of 1×10⁻⁶ cm²/Vs or more is preferable. As such aromatic hydrocarbon, for example, 2-tert-butyl-9,10-di(2-naphthyl)anthracene, anthracene, 9,10-diphenylanthracene, tetracene, rubrene, perylene, 2,5,8,11-tetra(tert-butyl)perylene, and the like are given. As the metal oxide, a metal oxide which shows an electron-accepting property to the aromatic hydrocarbon is preferable. As such metal oxide, for example, molybdenum oxide, vanadium oxide, ruthenium oxide, rhenium oxide, and the like are given.

One aspect of the present invention is a light emitting element having n (n is an arbitrary natural number of 2 or more) pieces of light emitting layers between a first electrode and a second electrode, and a first mixed layer and a second mixed layer between an m-th (m is an arbitrary natural number, 2≦m+1≦n) light emitting layer of layer and an (m+1)-th light emitting layer, wherein a light emitting substance included in the light emitting layer emits light when a voltage is applied to each of the electrodes so that the electric potential of the first electrode gets higher than that of the second electrode. Here, the first mixed layer is provided closer to the first electrode than the second mixed layer. The first mixed layer is a layer including an electron transporting substance and a substance selected from alkali metal, alkaline earth metal, alkali metal oxide, alkaline earth metal oxide, alkali metal fluoride, or alkaline earth metal fluoride. Here, as alkali metal, lithium (Li), natrium (Na), potassium (K), and the like are given, for example. As alkaline earth metal, magnesium (Mg), calcium (Ca), and the like are given, for example. As alkali metal oxide, lithium oxide (Li₂O), natrium oxide (Na₂O), potassium oxide (K₂O), and the like are given. As alkaline earth metal oxide, magnesium oxide (MgO), calcium oxide (CaO), and the like are given. As alkali metal fluoride, lithium fluoride (LiF), cesium fluoride (CsF), and the like are given. As alkaline earth metal fluoride, magnesium fluoride (MgF₂), calcium fluoride (CaF₂), and the like are given. The second mixed layer is a layer including an aromatic hydrocarbon and a metal oxide. Here, the kind of aromatic hydrocarbon is not particularly limited; however, a substance having hole mobility of 1×10⁻⁶ cm²/Vs or more is preferable. As such aromatic hydrocarbon, for example, 2-tert-butyl-9,10-di(2-naphthyl)anthracene, anthracene, 9,10-diphenylanthracene, tetracene, rubrene, perylene, 2,5,8,11-tetra(tert-butyl)perylene, and the like are given. As metal oxide, a metal oxide which shows an electron-accepting property to the aromatic hydrocarbon is preferable. As such metal oxide, for example, molybdenum oxide, vanadium oxide, ruthenium oxide, rhenium oxide, and the like are given.

One aspect of the present invention is a light emitting device using any of the light emitting elements described above as a pixel or a light source.

One aspect of the present invention is an electronic device in which a light emitting device using any of the light emitting elements described above as a pixel is used for a display portion.

One aspect of the present invention is an electronic device in which a light emitting device using any of the light emitting elements described above as a light source is used for a lighting portion.

By an implementation of the present invention, a light emitting element, in which an operation failure due to crystallization of a compound included in a layer provided between a pair of electrodes is reduced, can be obtained. This is because, by mixing an aromatic hydrocarbon and a metal oxide, crystallization of each of the aromatic hydrocarbon and the metal oxide is disturbed by each other, and accordingly, a layer which is not easily crystallized can be formed.

By an implementation of the present invention, a light emitting element, in which a length of a light path through which emitted light passes can be easily changed, can be obtained. This is because a light emitting element in which a drive voltage increases very little, which depends on increase in a thickness of a mixed layer, can be obtained by providing the mixed layer including aromatic hydrocarbon and metal oxide between the electrodes, and accordingly, a distance between a light emitting layer and the electrode can be adjusted easily.

By an implementation of the present invention, a light emitting element, in which a short circuit between electrodes is not easily generated, can be obtained. This is because a light emitting element in which a drive voltage increases very little, which depends on increase in a thickness of a mixed layer, can be obtained by providing the mixed layer including an aromatic hydrocarbon and a metal oxide between the electrodes, and accordingly, unevenness of an electrode can be relieved easily by a method of increasing a thickness of the mixed layer.

By an implementation of the present invention, a light emitting element which emits light with high color purity can be obtained, and accordingly, a light emitting device which can provide an image superior in color can be obtained. This is because, according to the light emitting element of the present invention, a light path length can be adjusted easily so as to be suitable for a wavelength of a light which is to be emitted by changing a length of a light path through which emitted light passes without concerning the increase in a drive voltage.

### BRIEF DESCRIPTION OF DRAWINGS

In the accompanying drawings:

FIG. 1 is an explanatory view of one mode of a light emitting element of the present invention;

FIG. 2 is an explanatory view of one mode of a light emitting element of the present invention;

FIG. 3 is an explanatory view of one mode of a light emitting element of the present invention;

FIG. 4 is an explanatory view of one mode of a light emitting element of the present invention;

FIG. 5 is an explanatory view of one mode of a light emitting element of the present invention;

FIG. 6 is an explanatory view of one mode of a light emitting element of the present invention;

FIG. 7 is an explanatory top view of one mode of a light emitting device of the present invention;

FIG. 8 is an explanatory diagram of one mode of a circuit for driving a pixel provided for a light emitting device of the present invention;

FIG. 9 is an explanatory view of one mode of a pixel portion included in a light emitting device of the present invention;

FIG. 10 is an explanatory frame view of a driving method for driving a pixel included in a light emitting device of the present invention;

FIGS. 11A to 11C are explanatory views of one mode of a cross section of a light emitting device of the present invention;

FIG. 12 is an explanatory view of one mode of a light emitting device of the present invention;

FIGS. 13A to 13C are explanatory views of one mode of an electronic device to which the present invention is applied;

FIG. 14 is an explanatory view of a lighting device to which the present invention is applied;

FIG. 15 is an explanatory view of a manufacturing method of a light emitting element in Embodiment 1;

FIG. 16 is a view showing voltage vs luminance characteristics of a light emitting element in Embodiment 1;

FIG. 17 is a view showing voltage vs current characteristics of a light emitting element in Embodiment 1;

FIG. 18 is a view showing luminance vs current efficiency characteristics of a light emitting element in Embodiment 1;

FIG. 19 is a view showing voltage vs current characteristics of an element in Embodiment 2; and

FIG. 20 is an explanatory view of one mode of a light emitting device of the present invention.

### BEST MODE FOR CARRYING OUT THE INVENTION

Embodiment Modes of the present invention will be explained below with reference to the accompanied drawings. However, it is to be easily understood that various changes and modifications will be apparent to those skilled in the art. Therefore, unless such changes and modifications depart from the scope of the invention, they should be construed as being included therein.

### Embodiment Mode 1

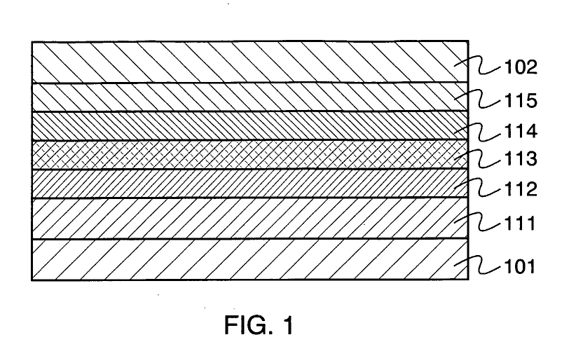

One mode of a light emitting element of the present invention will be explained with reference to FIG. 1.

FIG. 1 shows a light emitting element having a light emitting layer 113 between a first electrode 101 and a second electrode 102. In the light emitting element shown in FIG. 1, a mixed layer 111 is provided between the light emitting layer 113 and the first electrode 101. A hole transporting layer 112 is provided between the light emitting layer 113 and the mixed layer 111, and an electron transporting layer 114 and an electron injecting layer 115 are provided between the light emitting layer 113 and the second electrode 102. In such a light emitting element, when a voltage is applied to the first electrode 101 and the second electrode 102 so that the electric potential of the first electrode 101 gets higher than that of the second electrode 102, holes are injected in the light emitting layer 113 from the first electrode 101 side and electrons are injected in the light emitting layer 113 from the second electrode 102 side. Then, the holes and electrons injected into the light emitting layer 113 are recombined. The light emitting layer 113 includes a light emitting substance, which becomes an excited state by excitation energy which is generated due to the recombination. The light emitting substance in an excited state emits light upon returning to a ground state from the excited state.

Hereinafter, the first electrode 101, the second electrode 102, and each layer provided between the first electrode 101 and the second electrode 102 will be explained concretely.

A substance used for forming the first electrode 101 is not particularly limited, and a substance having a low work function such as aluminum or magnesium can be used besides a substance having a high work function such as indium tin oxide, indium tin oxide including silicon oxide, indium oxide including 2% to 20% zinc oxide, gold (Au), platinum (Pt), nickel (Ni), tungsten (W), chromium (Cr), molybdenum (Mo), iron (Fe), cobalt (Co), copper (Cu), palladium (Pd), or tantalum nitride. This is because, in the light emitting element of the present invention, holes are generated in the mixed layer 111.

A substance used for forming the second electrode 102 is preferably a substance having a low work function such as aluminum or magnesium; however, a substance having a high work function such as indium tin oxide, indium tin oxide including silicon oxide, indium oxide including 2% to 20% zinc oxide, gold (Au), platinum (Pt), nickel (Ni), tungsten (W), chromium (Cr), molybdenum (Mo), iron (Fe), cobalt (Co), copper (Cu), palladium (Pd), or tantalum nitride can also be used in a case where a layer which generates electrons is provided between the second electrode 102 and the light emitting layer 113. Therefore, a substance to be used as the substance for forming the second electrode 102 may be appropriately selected in accordance with properties of a layer provided between the second electrode 102 and the light emitting layer 113.

It is to be noted that the first electrode 101 and the second electrode 102 are preferably formed so that one or both of the electrodes can transmit light which is emitted.

The mixed layer 111 is a layer including an aromatic hydrocarbon and a metal oxide. The kind of aromatic hydrocarbon is not particularly limited; however, an aromatic hydrocarbon having hole mobility of 1×10⁻⁶ cm²/Vs or more is preferable. Holes donated from the metal oxide can be effectively transported by having hole mobility of 1×10⁻⁶ cm²/Vs or more. As such aromatic hydrocarbon having hole mobility of 1×10⁻⁶ cm²/Vs or more, for example, 2-tert-butyl-9,10-di(2-naphthyl)anthracene (abbreviation: t-BuDNA), anthracene, 9,10-diphenylanthracene, tetracene, rubrene, perylene, 2,5,8,11-tetra(tert-butyl)perylene, and the like are given. In addition, pentacene, coronene, or the like can also be used. As these aromatic hydrocarbons listed here, an aromatic hydrocarbon having hole mobility of 1×10⁻⁶ cm²/Vs or more and having 14 to 42 carbon atoms is more preferable. As the metal oxide, a metal oxide which shows an electron-accepting property to the aromatic hydrocarbon is preferable. As such metal oxide, for example, molybdenum oxide, vanadium oxide, ruthenium oxide, rhenium oxide, and the like are given. Further, a metal oxide such as titanium oxide, chromium oxide, zirconium oxide, hafnium oxide, tantalum oxide, tungsten oxide, or silver oxide can also be used. In the mixed layer 111, the metal oxide is preferably included so that a mass ratio is 0.5 to 2 or a molar ratio is 1 to 4 with respect to the aromatic hydrocarbon (=metal oxide/aromatic hydrocarbon). An aromatic hydrocarbon generally has a property of being crystallized easily; however, the aromatic hydrocarbon is not easily crystallized by being mixed with a metal oxide like this embodiment mode. A layer made of only a metal oxide shows a tendency to be crystallized easily, and this tendency is especially noticeable when molybdenum oxide is used as the metal oxide; however, molybdenum oxide is not easily crystallized by being mixed with an aromatic hydrocarbon like this embodiment mode. In this manner, by mixing the aromatic hydrocarbon and the metal oxide, crystallization of each of the aromatic hydrocarbon and the metal oxide is disturbed by each other, and accordingly, a layer which is not easily crystallized can be formed. Further, an aromatic hydrocarbon has a high glass transition temperature. Therefore, by employing an aromatic hydrocarbon for a substance included in the mixed layer 111 with a metal oxide, the mixed layer is to be superior in heat resistance to a hole injecting layer formed by using 4,4′,4″-tris(N,N-diphenylamino)triphenylamine (abbreviation: TDATA), 4,4′,4″-tris[N-(3-methylphenyl)-N-phenylamino]triphenylamine (abbreviation: MTDATA), or 4,4′-bis{N-[4-(N,N-di-m-tolylamino)phenyl]-N-phenylamino}biphenyl (abbreviation: DNTPD), and further has a function to favorably inject holes to the hole transporting layer 112.

The hole transporting layer 112 is a layer having a function to transport holes and, in a light emitting element of this embodiment mode, has a function to transport holes from the mixed layer 111 to the light emitting layer 113. By providing the hole transporting layer 112, an appropriate distance between the mixed layer 111 and the light emitting layer 113 can be kept. Consequently, light emission can be prevented from being quenched due to metal element included in the mixed layer 111. The hole transporting layer 112 is preferable to be made of a hole transporting substance and particularly preferable to be made of a hole transporting substance having hole mobility of 1×10⁻⁶ cm²/Vs or more or a bipolar substance having hole mobility of 1×10⁻⁶ cm²/Vs or more. It is to be noted that the hole transporting substance denotes a substance having higher hole mobility than electron mobility, and preferably, a substance having a value of a ratio of the hole mobility to the electron mobility (=hole mobility/electron mobility) of more than 100. The following is given as a specific example of the hole transporting substance: 4,4′-bis[N-(1-naphtyl)-N-phenylamino]biphenyl (abbreviation: NPB); 4,4′-bis[N-(3-methylphenyl)-N-phenylamino]biphenyl (abbreviation: TPD); 1,3,5-tris[N,N-di(m-tolyl)amino]benzene (abbreviation: m-MTDAB); 4,4′,4″-tris(N-carbazolyl)triphenylamine (abbreviation: TCTA); and the like. The bipolar substance denotes the following substance: when mobility of an electron and mobility of a hole are compared with each other, a value of a ratio of mobility of one carrier to mobility of the other carrier is 100 or less, preferably 10 or less. As the bipolar substance, for example, 2,3-bis(4-diphenylaminophenyl)quinoxaline (abbreviation: TPAQn); 2,3-bis{4-[N-(1-naphthyl)-N-phenylamino]phenyl}-dibenzo[f,h]quinoxaline (abbreviation: NPADiBzQn); and the like are given. In this invention, a bipolar substance having mobility of a hole and an electron of 1×10⁻⁶ cm²/Vs or more is preferably used among bipolar substances.

The light emitting layer 113 is a layer including a light emitting substance. Here, the light emitting substance denotes a substance which emits light effectively and can emit light with a desired wavelength. The light emitting layer 113 may be a layer made of only a light emitting substance. However, when a concentration quenching, which is a kind of quenching phenomenon caused by concentration of the light emitting substance itself, occurs, the light emitting layer 113 is preferable to be a layer in which a light emitting substance is mixed in a layer made of a substance having an energy gap larger than that of a light emitting substance in a dispersion state. By including a light emitting substance in the light emitting layer 113 in a dispersion state, light emission can be prevented from being quenched due to the concentration. Here, the energy gap denotes an energy gap between the LUMO level and the HOMO level.

The kind of light emitting substance is not particularly limited, and it is only necessary to use a substance which can emit light with favorable luminous efficiency and a desired emission wavelength. In order to obtain red light emission, for example, the following substances exhibiting emission spectrum with a peak in spectrum of 600 nm to 680 nm can be used as the light emitting substance: 4-dicyanomethylene-2-isopropyl-6-[2-(1,1,7,7-tetramethyl-9-julolidyl)ethenyl]-4H-pyran (abbreviation: DCJTI); 4-dicyanomethylene-2-methyl-6-[2-(1,1,7,7-tetramethyl-9-julolidyl)ethdnyl]-4H-pyran (abbreviation: DCJT); 4-dicyanomethylene-2-tert-butyl-6-[2-(1,1,7,7-tetramethyl-9-julolidyl)ethenyl]-4H-pyran (abbreviation: DCJTB); periflanthene; 2,5-dicyano-1,4-bis[2-(10-methoxy-1,1,7,7-tetramethyl-9-julolidyl)ethenyl]benzene; or the like. In order to obtain green light emission, substances exhibiting emission spectrum with a peak in a spectrum of 500 nm to 550 nm such as N,N′-dimethylquinacridone (abbreviation: DMQd), coumarin 6, coumarin 545T, or tris(8-quinolinolato)aluminum (abbreviation: Alq₃) can be used as the light emitting substance. In order to obtain blue light emission, the following substances exhibiting emission spectrum with a peak in a spectrum of 420 nm to 500 nm can be used as a light emitting substance: 9,10-bis(2-naphthyl)-tert-butylanthracene (abbreviation: t-BuDNA); 9,9′-bianthryl; 9,10-diphenylanthracene (abbreviation: DPA); 9,10-bis(2-naphthyl)anthracene (abbreviation: DNA); bis(2-methyl-8-quinolinolato)-4-phenylphenolato-gallium (abbreviation: BGaq); bis(2-methyl-8-quinolinolato)-4-phenylphenolato-aluminum (abbreviation: BAlq); or the like. As mentioned above, as well as a substance which emits fluorescence, the following substance which emits phosphorescence can also be used as the light emitting substance: bis[2-(3,5-bis(trifluoromethyl)phenyl)pyridinato-N,C^{2′}]iridium(III) picolinate (abbreviation: Ir(CF₃ ppy)₂(Pic)); bis[2-(4,6-difluorophenyl) pyridinato-N,C^{2′}]iridium(III)acetylacetonate (abbreviation: FIr(acac)); bis[2-(4,6-difluorophenyl)pyridinato-N,C^{2′}]iridium(III)picolinate (abbreviation: FIr(pic)); tris(2-phenylpyridinato-N,C^{2′})iridium (abbreviation: Ir(ppy)₃); or the like.

In addition, a substance which is included in the light emitting layer 113 along with the light emitting substance and used to make the light emitting substance be in dispersion state is not particularly limited. It is only necessary to select the substance appropriately in terms of an energy gap or the like of a substance which is used as a light emitting substance. For example, a metal complex such as bis[2-(2-hydroxyphenyl)pyridinato]zinc (abbreviation: Znpp₂) or bis[2-(2-hydroxyphenyl)benzoxazolato]zinc (abbreviation: ZnBOX) as well as an anthracene derivative such as 9,10-di(2-naphthyl)-2-tert-butylanthracene (abbreviation: t-BuDNA); a carbazole derivative such as 4,4′-bis(N-carbazolyl)biphenyl (abbreviation: CBP); a quinoxaline derivative such as 2,3-bis(4-diphenylaminophenyl)quinoxaline (abbreviation: TPAQn) or 2,3-bis{4-[N-(1-naphthyl)-N-phenylamino]phenyl}-dibenzo[f,h]quinoxaline (abbreviation: NPADiBzQn) can be used along with a light emitting substance.

The electron transporting layer 114 is a layer having a function to transport electrons and, in a light emitting element of this embodiment mode, has a function to transport electrons from the electron injecting layer 115 to the light emitting layer 113. By providing the electron transporting layer 114, an appropriate distance between the second electrode 102 and the light emitting layer 113 can be kept. Consequently, light emission can be prevented from being quenched due to metal included in the second electrode 102. The electron transporting layer is preferable to be made of an electron transporting substance and particularly preferable to be made of an electron transporting substance having electron mobility of 1×10⁻⁶ cm²/Vs or more or a bipolar substance having electron mobility of 1×10⁻⁶ cm²/Vs or more. The electron transporting substance denotes a substance having electron mobility higher than hole mobility, and preferably, a substance having a value of a ratio of the electron mobility to the hole mobility (=electron mobility/hole mobility) of more than 100. The following is given as a specific example of an electron transporting substance: 2-(4-biphenylyl)-5-(4-tert-buthylphenyl)-1,3,4-oxadiazole (abbreviation: PBD); 1,3-bis[5-(p-tert-buthylphenyl)-1,3,4-oxadiazole-2-yl]benzene (abbreviation: OXD-7); TAZ; p-EtTAZ; BPhen; BCP; 4,4-bis(5-methylbenzoxazolyl-2-yl)stilbene (abbreviation: BzOs); and the like as well as a metal complex such as tris(8-quinolinolato)aluminum (abbreviation: Alq₃); tris(4-methyl-8-quinolinolato)aluminum (abbreviation: Almq₃); bis(10-hydroxybenzo[h]-quinolinato)berylium (abbreviation: BeBq₂); bis(2-methyl-8-quinolinolato)-4-phenylphenolate-aluminum (abbreviation: BAlq); bis[2-(2-hydroxyphenyl)benzoxazolato]zinc (abbreviation: Zn(BOX)₂); and bis[2-(2-hydroxyphenyl)benzothiazolato]zinc (abbreviation: Zn(BTZ)₂). It is to be noted that the bipolar substance is described above. The electron transporting layer 114 and the hole transporting layer 112 may be made of the same bipolar substance.

The electron injecting layer 116 is a layer having a function to assist electrons to be injected from the second electrode 102 to the electron transporting layer 114. By providing the electron injecting layer 115, a difference in electron affinity between the second electrode 102 and the electron transporting layer 114 is relieved; thus, electrons are easily injected. The electron injecting layer 115 is preferably made of a substance of which electron affinity is higher than that of a substance for forming the electron transporting layer 114 and lower than that of a substance for forming the second electrode 102. Alternatively, the electron injecting layer 115 is preferably made of a substance of which energy band curves by being provided as a thin film of about 1 nm to 2 nm between the electron transporting layer 114 and the second electrode 102. The following is given as a specific example of a substance which can be used to form the electron injecting layer 115: an inorganic substance selected from the group consisting of alkali metal such as lithium (Li); alkaline earth metal such as magnesium (Mg); fluoride of alkali metal such as cesium fluoride (CsF); fluoride of alkaline earth metal such as calcium fluoride (CaF₂); oxide of alkali metal such as lithium oxide (Li₂O), natrium oxide (Na₂O), or potassium oxide (K₂O); and oxide of alkaline earth metal such as calcium oxide (CaO) or magnesium oxide (MgO). These substances are preferable because the energy band curves by being provided as a thin film. In addition to the inorganic substance, an organic substance which can be used to form the electron transporting layer 114, such as bathophenanthroline (abbreviation: BPhen); bathocuproin (abbreviation: BCP); 3-(4-tert-buthylphenyl)-4-(4-ethylphenyl)-5-(4-biphenylyl)-1,2,4-triazole (abbreviation: p-EtTAZ); or 3-(4-tert-buthylphenyl)-4-phenyl-5-(4-biphenylyl)-1,2,4-triazole (abbreviation: TAZ), can also be used as a substance for forming the electron injecting layer 115 by selecting a substance of which electron affinity is higher than that of a substance for forming the electron transporting layer 114 among these substances. In other words, the electron injecting layer 115 may be formed by selecting a substance so as to have higher electron affinity in the electron injecting layer 115 than electron affinity in the electron transporting layer 114. It is to be noted that the second electrode 102 is preferably made of a substance having a low work function such as aluminum in a case of providing the electron injecting layer 115.

In the light emitting element explained as above, each of the electron transporting substance and aromatic hydrocarbon is preferably selected so that a ratio of mobility of one substance to mobility of another substance is 1000 or less when mobility of an electron transporting substance used for forming the electron transporting layer 114 and mobility of aromatic hydrocarbon included in the mixed layer 111. Thus, recombination efficiency in the light emitting layer can be increased by selecting each substance.

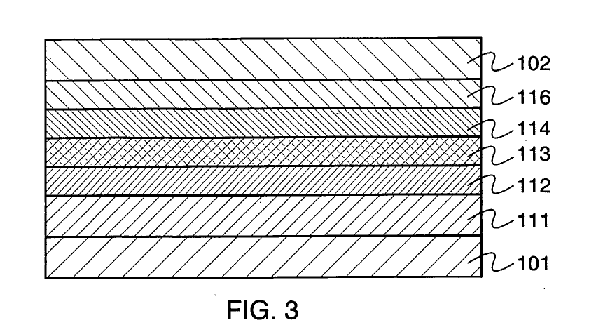

In this embodiment mode, the light emitting element having the hole transporting layer 112, the electron transporting layer 114, the electron injecting layer 115, and the like as well as the mixed layer 111 and the light emitting layer 113 is shown; however, a mode of the light emitting element is not limited thereto. For example, as shown in FIG. 3, a structure having an electron-generating layer 116 and the like instead of the electron injecting layer 115 may be employed. The electron-generating layer 116 is a layer which generates electrons, which can be formed by mixing at least one substance of an electron transporting substance and a bipolar substance with a substance which shows an electron-donating property to these substances. Here, it is preferable to particularly use a substance having electron mobility of 1×10⁻⁶ cm²/Vs or more in the electron transporting substance and the bipolar substance. As for the electron transporting substance and the bipolar substance, the above mentioned substances can be used for each. In addition, as for the substance which shows an electron-donating property, a substance of alkali metal or alkaline earth metal, specifically lithium (Li), calcium (Ca), natrium (Na), potassium (K), magnesium (Mg), or the like can be used. Moreover, alkali metal oxide, alkaline earth metal oxide, alkali metal fluoride, or alkaline earth metal fluoride, specifically at least one substance of lithium oxide (Li₂O), calcium oxide (CaO), natrium oxide (Na₂O), potassium oxide (K₂O), magnesium oxide (MgO), lithium fluoride (LiF), cesium fluoride (CsF), calcium fluoride (CaF2), or the like can also be used as the substance which shows an electron-donating property.

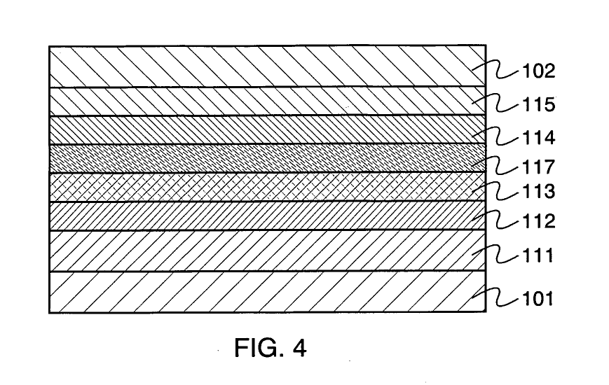

In addition, a hole blocking layer 117 may be provided between the light emitting layer 113 and the electron transporting layer 114 as shown in FIG. 4. By providing the hole blocking layer 117, holes can be prevented from flowing to the second electrode 102 side by passing through the light emitting layer 113; thus, recombination efficiency of carriers can be increased. Moreover, excitation energy generated in the light emitting layer 113 can be prevented from having translated to other layers such as the electron transporting layer 114. The hole blocking layer 117 can be formed by using a substance having higher ionization potential and higher excitation energy than a substance which is used to form the light emitting layer 113 and selected from among substances which can be used to form the electron transporting layer 114 such as BAlq, OXD-7, TAZ, and BPhen. In other words, it is only necessary that the hole blocking layer 117 is formed by selecting a substance so that ionization potential in the hole blocking layer 117 is higher than that in the electron transporting layer 114. In the same manner, a layer for blocking an electron from flowing to the second electrode 102 side after passing through the light emitting layer 113 may also be provided between the light emitting layer 113 and the hole transporting layer 112.

It is to be noted that whether the electron injecting layer 115, the electron transporting layer 114, and the hole transporting layer 112 are to be provided or not may be appropriately decided by a practitioner of the present invention, and these layers are not always necessary to be provided, for example, in a case where there is no malfunction such as quenching due to metal even when the hole transporting layer 112, the electron transporting layer 114, and the like are not provided, or a case where electrons are favorably injected from an electrode even when the electron injecting layer 115 is not provided.

As described above, by using a light emitting element having the mixed layer 111 including aromatic hydrocarbon and metal oxide, a failure due to crystallization of a layer provided between a pair of electrodes, for example, a short circuit or the like between the pair of electrodes which occurs as a result of the generation of unevenness of a layer supporting an injection of hole, or the like by crystallization can be reduced more than a light emitting element provided with a layer made of only an aromatic hydrocarbon or a metal oxide. Further, holes can be generated in the mixed layer 111; therefore, a light emitting element with little change in a drive voltage which depends on a thickness of the mixed layer 111 can be obtained by providing the mixed layer 111 including aromatic hydrocarbon and metal oxide. Hence, a distance between the light emitting layer 113 and the first electrode 101 can be adjusted easily by changing a thickness of the mixed layer 111. In other words, a length of a light path through which emitted light passes (i.e. light path length) is adjusted easily so as to be a length enough to extract light emission outside efficiently or a length by which color purity of light emission extracted outside is favorable. In addition, unevenness of a surface of the first electrode 101 can be relieved and a short circuit between the electrodes can be reduced by thickening the mixed layer 111.

The light emitting element explained as above may be manufactured by a method for forming the second electrode 102 after sequentially stacking the mixed layer 111, the hole transporting layer 112, the light emitting layer 113, the electron transporting layer 114, the electron injecting layer 115, and the like on the first electrode 101, or may be manufactured by a method for forming the first electrode 101 after sequentially stacking the electron injecting layer 115, the electron transporting layer 114, the light emitting layer 113, the hole transporting layer 112, the mixed layer 111, and the like on the second electrode 102. By forming the mixed layer 111 after forming the light emitting layer 113 as the latter method, the mixed layer 111 serves as a protective layer; therefore, a favorable light emitting element, in which a layer made of an organic compound such as the light emitting layer 113 is not easily damaged by sputtering, can be manufactured even when the first electrode 101 is formed by a sputtering method.

### Embodiment Mode 2

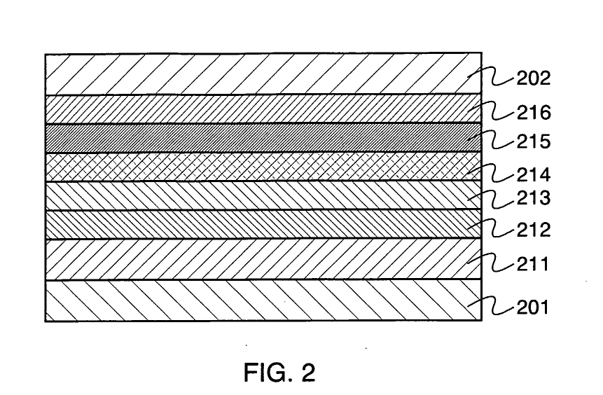

One mode of a light emitting element of the present invention will be explained with reference to FIG. 2.

FIG. 2 shows a light emitting element having a light emitting layer 213, a first mixed layer 215, and a second mixed layer 216 between a first electrode 201 and a second electrode 202, in which the light emitting layer 213 is provided closer to the first electrode 201 than the first mixed layer 215, and the second mixed layer 216 is provided closer to the second electrode 202 than the first mixed layer 215. In this light emitting element, a hole injecting layer 211 and a hole transporting layer 212 are provided between the light emitting layer and the first electrode 201, and an electron transporting layer 214 is provided between the light emitting layer 213 and the first mixed layer 215. The first mixed layer 215 is a layer including an electron transporting substance and a substance selected from alkali metal, alkaline earth metal, alkali metal oxide, alkaline earth metal oxide, alkali metal fluoride, and alkaline earth metal fluoride. The second mixed layer 216 is a layer including an aromatic hydrocarbon and a metal oxide. The light emitting layer 213 includes a light emitting substance. When a voltage is applied to each of the electrodes so that the electric potential of the first electrode 201 gets higher than the electric potential of the second electrode 202, electrons are injected from the first mixed layer 215 to the electron transporting layer 214, holes are injected from the second mixed layer 216 to the second electrode 202, and further, holes are injected from the first electrode 201 to the hole injecting layer 211. Then, the holes injected into the light emitting layer 213 from the first electrode 201 side and electrons injected into the light emitting layer 213 from the second electrode 202 side are recombined, and accordingly, the light emitting substance included in the light emitting layer 213 becomes an excited state by excitation energy which is generated due to the recombination. The light emitting substance in an excited state emits light upon returning to a ground state from the excited state.

Hereinafter, the first electrode 201, the second electrode 202, and each layer provided between the first electrode 201 and the second electrode 202 will be explained concretely.

A substance used for forming the first electrode 201 is preferably a substance having a high work function such as indium tin oxide, indium tin oxide including silicon oxide, indium oxide including 2% to 20% zinc oxide, gold (Au), platinum (Pt), nickel (Ni), tungsten (W), chromium (Cr), molybdenum (Mo), iron (Fe), cobalt (Co), copper (Cu), palladium (Pd), or tantalum nitride.

A substance used for forming the second electrode 202 is preferably a substance having a low work function such as aluminum or magnesium; however, a substance having a high work function such as indium tin oxide, indium tin oxide including silicon oxide, indium oxide including 2% to 20% zinc oxide, gold (Au), platinum (Pt), nickel (Ni), tungsten (W), chromium (Cr), molybdenum (Mo), iron (Fe), cobalt (Co), copper (Cu), palladium (Pd), or tantalum nitride can also be used in a case of providing a layer which generates electrons between the second electrode 202 and the light emitting layer 213. Therefore, a substance to be used as the substance for forming the second electrode 202 may be appropriately selected in accordance with properties of a layer provided between the second electrode 202 and the light emitting layer 213.

It is to be noted that the first electrode 201 and the second electrode 202 are preferably formed so that one or both of the electrodes can transmit light which is emitted.

The hole injecting layer 211 is a layer having a function to assist holes to be injected from the first electrode 201 to the hole transporting layer 212. By providing the hole injecting layer 211, ionization potential difference between the first electrode 201 and the hole transporting layer 212 is relieved; thus, holes are easily injected. The hole injecting layer 211 is preferably made of a substance of which ionization potential is lower than that of a substance for forming the hole transporting layer 212 and higher than that of a substance for forming the first electrode 201. As a specific example of a substance which can be used to form the hole injecting layer 211, a low molecular compound such as phthalocyanine (abbreviation: H₂Pc) or copper phthalocyanine (abbreviation: CuPC), high molecular compound such as poly(ethylenedioxythiophene)/poly(styrene sulfonate) water solution (abbreviation: PEDOT/PSS), and the like are given.

The hole transporting layer 212 is a layer having a function to transport holes and, in a light emitting element of this embodiment mode, has a function to transport holes from the hole injecting layer 211 to the light emitting layer 213. By providing the hole transporting layer 212, an appropriate distance between the first electrode 201 and the light emitting layer 213 can be kept. Consequently, light emission can be prevented from being quenched due to metal element included in the first electrode 201. The hole transporting layer 212 is preferable to be made of a hole transporting substance and particularly preferable to be made of a hole transporting substance having hole mobility of 1×10⁻⁶ cm²/Vs or more or a bipolar substance having hole mobility of 1×10⁻⁶ cm²/Vs or more. As for a hole transporting substance and a bipolar substance, the description of the hole transporting substance and the bipolar substance in Embodiment Mode 1 is applied correspondingly, and explanation is omitted in this embodiment mode.

The light emitting layer 213 is a layer including a light emitting substance. The light emitting layer 213 may be a layer made of only a light emitting substance. However, when a concentration quenching occurs, the light emitting layer 213 is preferable to be a layer in which a light emitting substance is mixed in a layer made of a substance having an energy gap larger than that of a light emitting substance in a dispersion state. By including a light emitting substance in the light emitting layer 213 in a dispersion state, light emission can be prevented from being quenched due to the concentration. Here, the energy gap denotes an energy gap between the LUMO level and the HOMO level. As for a light emitting substance and a substance used to make the light emitting substance be in dispersion state, the description of the light emitting substance and the substance used to make the light emitting substance be in dispersion state, in Embodiment Mode 1 is applied correspondingly, and explanation is omitted in this embodiment mode.

The electron transporting layer 214 is a layer having a function to transport electrons and, in a light emitting element of this embodiment mode, has a function to transport electrons injected from the first mixed layer 215 to the light emitting layer 213. By providing the electron transporting layer 214, an appropriate distance between the second mixed layer 216 and the light emitting layer 213 can be kept. Consequently, light emission can be prevented from being quenched due to metal element included in the second mixed layer 216 (due to metal element in a case where metal element is included in the first mixed layer 215). The electron transporting layer 214 is preferable to be made of an electron transporting substance and particularly preferable to be made of an electron transporting substance having electron mobility of 1×10⁻⁶ cm²/Vs or more or a bipolar substance having electron mobility of 1×10⁻⁶ cm²/Vs or more. As for an electron transporting substance and a bipolar substance, the description of the electron transporting substance and the bipolar substance in Embodiment Mode 1 is applied correspondingly, and explanation is omitted in this embodiment mode.

The first mixed layer 215 is a layer which generates electrons, which can be formed by mixing at least one substance of an electron transporting substance and a bipolar substance with a substance which shows an electron-donating property to these substances. Here, it is preferable to particularly use a substance having electron mobility of 1×10⁻⁶ cm²/Vs or more among the electron transporting substance and the bipolar substance. As for the electron transporting substance and the bipolar substance, the description of the electron transporting substance and the bipolar substance is applied correspondingly, and explanation is omitted here. Further, as for the substance which shows an electron-donating property to the electron transporting substance and the bipolar substance, the description of the substance which shows an electron-donating property is applied correspondingly, and explanation is omitted here.

The second mixed layer 216 is a layer including an aromatic hydrocarbon and a metal oxide. The kind of aromatic hydrocarbon is not particularly limited; however, an aromatic hydrocarbon having hole mobility of 1×10⁻⁶ cm²/Vs or more is preferable. Holes injected from the metal oxide can be effectively transported by having hole mobility of 1×10⁻⁶ cm²/Vs or more. As aromatic hydrocarbon having hole mobility of 1×10⁻⁶ cm²/Vs or more, for example, 2-tert-butyl-9,10-di(2-naphthyl)anthracene (abbreviation: t-BuDNA), anthracene, 9,10-diphenylanthracene, tetracene, rubrene, perylene, 2,5,8,11-tetra(tert-butyl)perylene, and the like are given. In addition, pentacene, coronene, or the like can also be used. As these aromatic hydrocarbons listed here, an aromatic hydrocarbon having hole mobility of 1×10⁻⁶ cm²/Vs or more and having 14 to 42 carbon atoms is preferably used. As the metal oxide, a metal oxide which shows an electron-accepting property to the aromatic hydrocarbon is preferable. As such metal oxide, for example, molybdenum oxide, vanadium oxide, ruthenium oxide, rhenium oxide, and the like are given. Further, a metal oxide such as titanium oxide, chromium oxide, zirconium oxide, hafnium oxide, tantalum oxide, tungsten oxide, or silver oxide can also be used. In the second mixed layer 216, the metal oxide is preferably included so that a mass ratio is 0.5 to 2 or a molar ratio is 1 to 4 with respect to aromatic hydrocarbon (=metal oxide/aromatic hydrocarbon). An aromatic hydrocarbon generally has a property of being crystallized easily; however, the aromatic hydrocarbon is not easily crystallized by being mixed with a metal oxide like this embodiment mode. A layer made of only a metal oxide shows a tendency to be crystallized easily, and this tendency is especially noticeable when molybdenum oxide is used as the metal oxide; however, molybdenum oxide is not easily crystallized by being mixed with an aromatic hydrocarbon like this embodiment mode. In this manner, by mixing the aromatic hydrocarbon and the metal oxide, crystallization of each of the aromatic hydrocarbon and the metal oxide is disturbed by each other, and accordingly, a layer which is not easily crystallized can be formed.

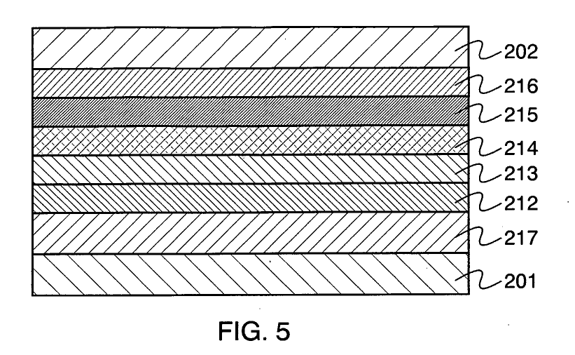

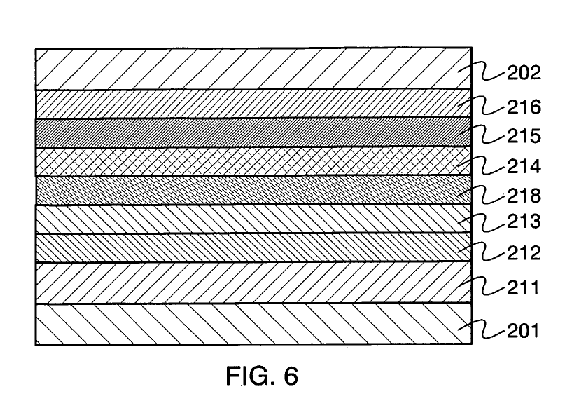

In this embodiment mode, a light emitting element having the hole injecting layer 211, the hole transporting layer 212, the electron transporting layer 214, and the like as well as the light emitting layer 213, the first mixed layer 215, and the second mixed layer 216, is shown; however, a mode of a light emitting element is not limited thereto. For example, as shown in FIG. 5, a structure provided with a layer 217 or the like including an aromatic hydrocarbon and a metal oxide, which is the same as the second mixed layer 216, instead of the hole injecting layer 211 may be employed. By providing the layer 217 including an aromatic hydrocarbon and a metal oxide, a light emitting element can be operated favorably even in a case of forming the first electrode 201 using a substance having a low work function such as aluminum or magnesium. Further, as shown in FIG. 6, a hole blocking layer 218 may be provided between the electron transporting layer 214 and the light emitting layer 213. The hole blocking layer 218 is similar to the hole blocking layer 117 mentioned in Embodiment Mode 1; therefore, the explanation is omitted.

It is to be noted that whether the hole injecting layer 211, the hole transporting layer 212, and the electron transporting layer 214 are to be provided or not may be appropriately decided by a practitioner of the invention, and these layers are not always necessary to be provided, for example, in a case where there is no malfunction such as quenching due to metal element even when the hole transporting layer 212, the electron transporting layer 214, and the like are not provided, or a case where holes are favorably injected from an electrode even when the hole injecting layer 211 is not provided.

As described above, by using a light emitting element having the second mixed layer 216 including aromatic hydrocarbon and metal oxide, a failure due to crystallization of a layer provided between a pair of electrodes, for example, a short circuit or the like between the pair of electrodes which occurs as a result of the generation of unevenness of a layer supporting an injection of hole, or the like by crystallization can be reduced more than a light emitting element provided with a layer made of only an aromatic hydrocarbon or a metal oxide. Further, holes can be generated in the second mixed layer 216; therefore, a light emitting element with little change in a drive voltage which depends on a thickness of the second mixed layer 216 can be obtained by providing the second mixed layer 216 including aromatic hydrocarbon and metal oxide. Hence, a distance between the light emitting layer 213 and the second electrode 202 can be adjusted easily by changing a thickness of the second mixed layer 216. In other words, a length of a light path through which emitted light passes (i.e. light path length) is adjusted easily so as to be a length enough to extract light emission outside efficiently or a length by which color purity of light emission extracted outside is favorable. In addition, unevenness of a surface of the second electrode 202 can be relieved and a short circuit between the electrodes can be reduced by thickening the second mixed layer 216.

Further, by providing a layer including aromatic hydrocarbon and metal oxide also in the first electrode 201 side instead of the hole injecting layer 211, a distance between the first electrode 201 and the light emitting element 213 can be adjusted easily. In addition, unevenness of a surface of the first electrode 201 can be relieved and a short circuit between the electrodes can be reduced.

The light emitting element explained as above may be manufactured by a method for forming the first electrode 201 first, then forming each layer such as the light emitting layer 213, and then forming the second electrode 202, or may be manufactured by a method for forming the second electrode 202 first, then forming each layer such as the light emitting layer 213, and then forming the first electrode 201. By forming a layer including aromatic hydrocarbon and metal oxide after forming the light emitting layer 213 in both of the methods, the layer including aromatic hydrocarbon and metal oxide serves as a protective layer; therefore, a favorable light emitting element, in which a layer made of an organic compound such as the light emitting layer 213 is not easily damaged by sputtering, can be manufactured even when the electrode (the first electrode 201 or the second electrode 202) is formed by a sputtering method.

### Embodiment Mode 3

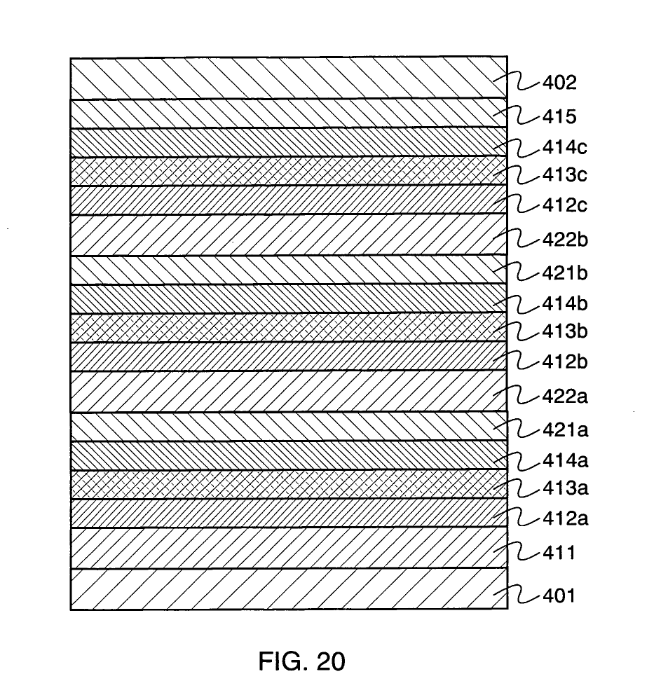

One mode of a light emitting element of the present invention will be explained with reference to FIG. 20. FIG. 20 shows a light emitting element having a plurality of light emitting layers, specifically, a first light emitting layer 413a, a second light emitting layer 413b, and a third light emitting layer 413c between a first electrode 401 and a second electrode 402. This light emitting element has a first mixed layer 421a and a second mixed layer 422a between the first light emitting layer 413a and the second light emitting layer 413b, and a first mixed layer 421b and a second mixed layer 422b between the second light emitting layer 413b and the third light emitting layer 413c. The first mixed layers 421a and 421b are layers including an electron transporting substance and a substance selected from alkali metal, alkali earth metal, alkali metal oxide, alkaline earth metal oxide, alkali metal fluoride, and alkaline earth metal fluoride. The second mixed layers 422a and 422b are layers including aromatic hydrocarbon and metal oxide. The first mixed layer 421a is provided closer to the first electrode 401 than the second mixed layer 422a, and the first mixed layer 421b is provided closer to the first electrode 401 than the second mixed layer 422b. Hole transporting layers 412a, 412b, and 412c are provided between the first electrode 401 and the first light emitting layer 413a, between the second mixed layer 422a and the second light emitting layer 413b, and between the second mixed layer 422b and the third light emitting layer 413c, respectively. Further, electron transporting layers 414a, 414b, and 414c are provided between the first light emitting layer 413a and the first mixed layer 421a, between the second light emitting layer 413b and the first mixed layer 421b, and between the third light emitting layer 413c and the second electrode 402, respectively. Furthermore, a hole injecting layer 411 is provided between the first electrode 401 and the hole transporting layer 412a, and an electron injecting layer 415 is provided between the second electrode 402 and the electron transporting layer 414c. A light emitting substance is included in the first light emitting layer 413a, the second light emitting layer 413b, and the third light emitting layer 413c. When a voltage is applied to each of the electrodes so that the electric potential of the first electrode 401 gets higher than that of the second electrode 402, holes and electrons are recombined in each of the light emitting layers, and a light emitting substance included in each of the light emitting layers becomes an excited state by excitation energy which is generated due to the recombination. The light emitting substance in an excited state emits light upon returning to a ground state from the excited state. It is to be noted that light emitting substances included in each of the light-emitting layers may be the same or different.

A substance used for forming the first electrode 401 is preferably a substance having a high work function such as indium tin oxide, indium tin oxide including silicon oxide, indium oxide including 2% to 20% zinc oxide, gold (Au), platinum (Pt), nickel (Ni), tungsten (W), chromium (Cr), molybdenum (Mo), iron (Fe), cobalt (Co), copper (Cu), palladium (Pd), or tantalum nitride. Further, the first electrode 401 can be made of a substance having a low work function such as aluminum or magnesium in a case of providing a layer including aromatic hydrocarbon and metal oxide instead of the hole injecting layer 411.

A substance used for forming the second electrode 402 is preferably a substance having a low work function such as aluminum or magnesium; however, a substance having a high work function such as indium tin oxide, indium tin oxide including silicon oxide, indium oxide including 2% to 20% zinc oxide, gold (Au), platinum (Pt), nickel (Ni), tungsten (W), chromium (Cr), molybdenum (Mo), iron (Fe), cobalt (Co), copper (Cu), palladium (Pd), or tantalum nitride can also be used in a case of providing a layer which generates electrons between the second electrode 402 and the third light emitting layer 413c. Therefore, a substance to be used as the substance for forming the second electrode 402 may be appropriately selected in accordance with properties of a layer provided between the second electrode 402 and the third light emitting layer 413c.

In the light emitting element of this embodiment mode as described above, the first mixed layers 421a and 421b are similar to the first mixed layer 215 mentioned in Embodiment Mode 2. Further, the second mixed layers 422a and 422b are similar to the second mixed layer 216 mentioned in Embodiment Mode 2. Furthermore, each of the first light emitting layer 413a, the second light emitting layer 413b, and the third light emitting layer 413c is similar to the light emitting layer 213 in Embodiment Mode 2. The hole injecting layer 411; the hole transporting layers 412a, 412b, and 412c; the electron transporting layers 414a, 414b, and 414c; and the electron injecting layer 415 are similar to the layers mentioned by the same name in Embodiment Mode 2, respectively.

As described above, by using a light emitting element having the second mixed layers 422a and 422b including an aromatic hydrocarbon and a metal oxide, a failure due to crystallization of a layer provided between a pair of electrodes, for example, a short circuit or the like between the pair of electrodes which occurs as a result of the generation of unevenness of a layer supporting an injection of hole, or the like by crystallization can be reduced more than a light emitting element provided with a layer made of only an aromatic hydrocarbon or a metal oxide. Further, by employing a structure provided with the second mixed layers 422a and 422b each including an aromatic hydrocarbon and a metal oxide, a light emitting element can be obtained, in which a layer made of an organic compound such as a light emitting layer is not easily damaged by sputtering compared with a light emitting element having a structure provided with a layer formed by sputtering, such as a layer made of indium tin oxide, between each light emitting layer.

### Embodiment Mode 4

According to a light emitting element of the present invention, an operation failure due to crystallization of a layer provided between a pair of electrodes can be reduced. Further, a short circuit between the pair of electrodes can be prevented by thickening a mixed layer including an aromatic hydrocarbon and a metal oxide, which is provided between the pair of electrodes. Furthermore, according to a light emitting element of the present invention, light emission can be extracted outside efficiently by adjusting a light path length by changing a thickness of the mixed layer. Moreover, light emission having preferable color purity can be obtained. Therefore, by using the light emitting element of the present invention as a pixel, a favorable light emitting device with quite a few display defects due to an operation failure of a light emitting element can be obtained. Further, by using the light emitting element of the present invention as a pixel, a light emitting device which can provide an image with a favorable display color can be obtained. Furthermore, by using the light emitting element of the present invention as a light source, a light emitting device which can light favorably with a little malfunction due to an operation failure of a light emitting element can be obtained.

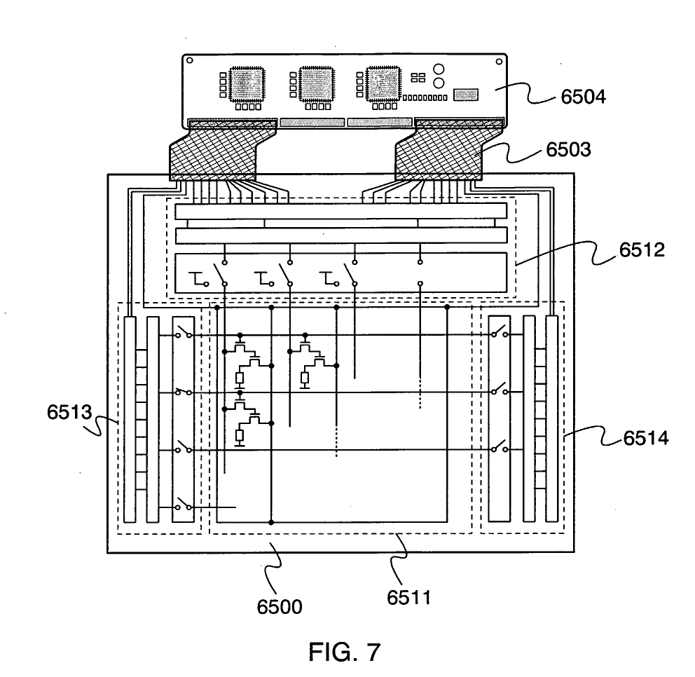

In this embodiment mode, a circuit configuration of a light emitting device having a display function and a driving method thereof will be explained with reference to FIGS. 7 to 11C.

FIG. 7 is a schematic top view of a light emitting device to which the present invention is applied. In FIG. 7, a pixel portion 6511, a source signal line driver circuit 6512, a writing gate signal line driver circuit 6513, and an erasing gate signal line driver circuit 6514 are provided on a substrate 6500. The source signal line driver circuit 6512, the writing gate signal line driver circuit 6513, and the erasing gate signal line driver circuit 6514 are connected to an FPC (flexible printed circuit) 6503, which is an external input terminal, through a group of wirings, respectively. The source signal line driver circuit 6512, the writing gate signal line driver circuit 6513, and the erasing gate signal line driver circuit 6514 receive a video signal, a clock signal, a start signal, a reset signal, and the like from the FPC 6503, respectively. A printed wiring board (PWB) 6504 is attached to the FPC 6503. A driver circuit portion is not necessarily provided on the same substrate as the pixel portion 6511 as described above. For example, the driver circuit portion may be provided outside the substrate utilizing a TPC or the like which is formed by mounting an IC chip on an FPC provided with a wiring pattern.

In the pixel portion 6511, a plurality of source signal lines extended in a column direction is arranged in a row direction and current supply lines are arranged in the row direction. In the pixel portion 6511, a plurality of gate signal lines extended in the row direction are arranged in the column direction. Further, in the pixel portion 6511, a plurality of pixel circuits including the light emitting element is arranged.

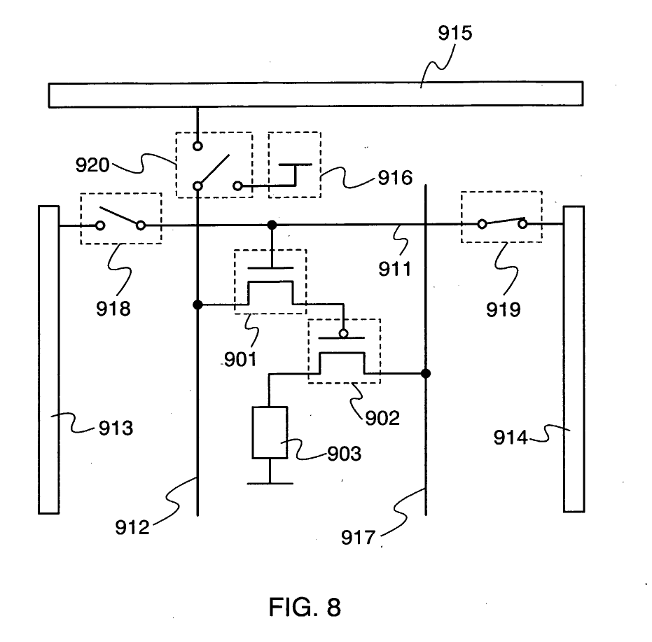

FIG. 8 is a diagram showing a circuit for making one pixel operate. A first transistor 901, a second transistor 902, and a light emitting element 903 are included in the circuit shown in FIG. 8.

The first transistor 901 and the second transistor 902 each have three terminals including a gate electrode, a drain region, and a source region and have a channel region between the drain region and the source region. Here, since the source region and the drain region are determined according to the structure, operation condition, or the like of the transistor, it is difficult to confine which is the source region or the drain region. Therefore, in this embodiment mode, regions which serve as a source or a drain are respectively referred to as a first electrode or a second electrode.

A gate signal line 911 and a writing gate signal line driver circuit 913 are provided so as to be electrically connected or disconnected to each other through a switch 918. The gate signal line 911 and an erasing gate signal line driver circuit 914 are provided so as to be electrically connected or disconnected to each other through a switch 919. A source signal line 912 is provided so as to be electrically connected to one of a source signal line driver circuit 915 and a power source 916 through a switch 920. A gate of the first transistor 901 is electrically connected to the gate signal line 911. A first electrode of the first transistor is electrically connected to the source signal line 912 and a second electrode thereof is electrically connected to a gate electrode of the second transistor 902. A first electrode of the second transistor 902 is electrically connected to a current supply line 917, and a second electrode thereof is electrically connected to one of electrodes included in the light emitting element 903. Further, the switch 918 may be included in the writing gate signal line driver circuit 913. The switch 919 may be also included in the erasing gate signal line driver circuit 914. In addition, the switch 920 may be included in the source signal line driver circuit 915.

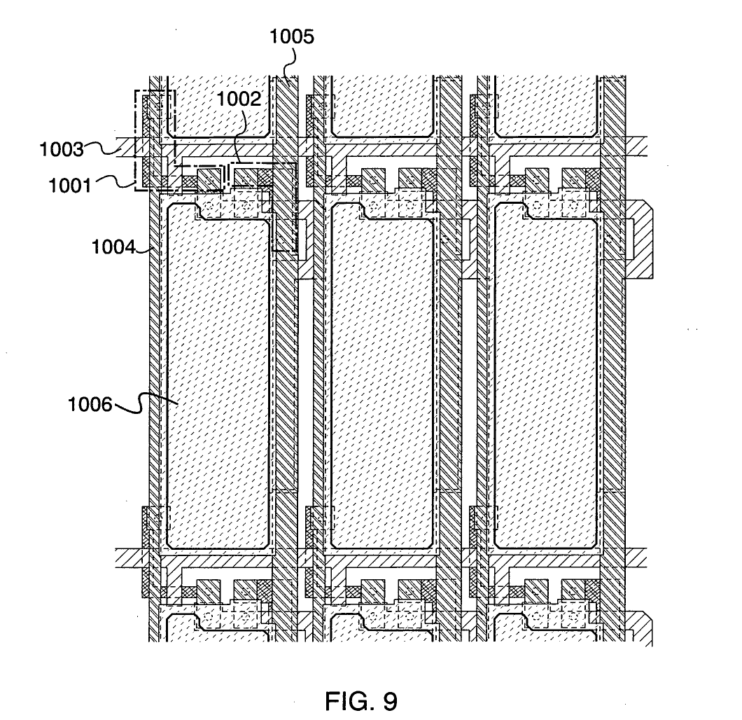

The arrangement of the transistor, the light emitting element, or the like in the pixel portion is not particularly limited; however, the transistor, the light emitting element, or the like can be arranged, for example, as shown in a top view of FIG. 9. In FIG. 9, a first electrode of a first transistor 1001 is connected to a source signal line 1004, and a second electrode thereof is connected to a gate electrode of a second transistor 1002. A first electrode of the second transistor is connected to a current supply line 1005, and a second electrode thereof is connected to an electrode 1006 of the light emitting element. A part of a gate signal line 1003 serves as a gate electrode of the first transistor 1001.

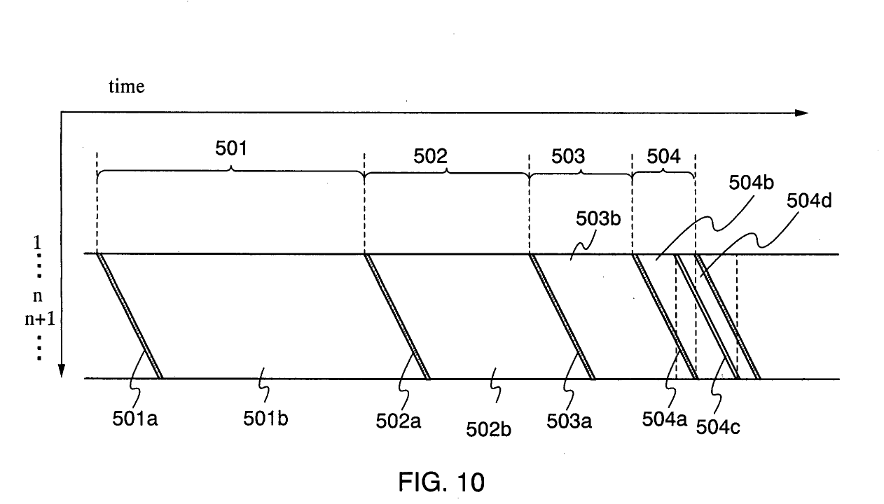

Next, a driving method is explained. FIG. 10 is an explanatory view of a frame operation with time. In FIG. 10, a horizontal direction represents time passage, whereas a longitudinal direction represents scanning stages of a gate signal line.

When an image is displayed using a light emitting device according to the invention, a rewriting operation and a displaying operation of a screen are repeatedly carried out in a display period. The number of rewriting operations is not particularly limited; however, the rewriting operation is preferably performed at least approximately sixty times per second so that a person who watches the image does not find flickering. Herein, the period of carrying out the rewriting operation and displaying operation of one screen (one frame) is referred to as one frame period.

One frame period is time-divided into four sub-frame periods 501, 502, 503, and 504 including writing periods 501a, 502a, 503a, and 504a, and retention periods 501b, 502b, 503b, and 504b as shown in FIG. 10. A light emitting element which receives a signal for light emission emits light in the retention period. The length ratio of the retention period in each sub-frame period is the first sub-frame period 501 the second sub-frame period 502: the third sub-frame period 503: the fourth sub-frame period 504=2³:2²:2¹:2⁰=8:4:2:1. Accordingly, a 4-bit gray scale can be realized. The number of bits and gray scale levels is not limited thereto. For instance, an 8-bit gray scale can be offered by providing eight sub-frame periods.

An operation in one frame period is explained. Firstly, a writing operation is sequentially carried out from the first row to the last row in the sub-frame period 501. Therefore, the starting time of the writing period is different depending on the rows. The retention period 501b sequentially starts from the row where the writing period 501a is completed. In the retention period, a light emitting element which receives a signal for light emission emits light. The next sub-frame period 502 sequentially starts from the row where the retention period 501b is completed, and a writing operation is sequentially carried out from the first row to the last row as is the case with the sub-frame period 501. Operations as noted above are repeatedly carried out to finish the retention period 504b of the sub-frame period 504. When the operation in the sub-frame period 504 is completed, an operation in the next frame period is started. The sum of light emission time in each sub-frame period is a light emission time of each light emitting element in one frame period. By changing the light emission time for each light emitting element and combining the light emission time variously in one pixel, various colors can be displayed with different brightness and chromaticity.

When a retention period in the row where writing has been already finished and the retention period has started is intended to be forcibly terminated before finishing the writing of the last row, an erasing period 504c is provided after the retention period 504b to control so that the light emission is forcibly stopped. The row where the light emission is forcibly stopped does not emit light during a fixed period (the period is referred to as a non-light-emitting period 504d). Upon finishing the writing period of the last row, the next writing period (or a frame period) sequentially starts from the first row. According to this, a writing period of the sub-frame period 504 and a writing period of the next sub-frame period can be prevented from overlapping.

In this embodiment mode, the sub-frame periods 501 to 504 are arranged in the order from the longest retention period; however, the invention is not limited thereto. For instance, the sub-frame periods 501 to 504 may be arranged in the order from the shortest retention period or may be arranged at random combining short sub-frame periods and long sub-frame periods. The sub-frame period may be further divided into a plurality of frame periods. That is, scanning of the gate signal line may be carried out a plurality of times during the period of giving the same video signal.

The operation of the circuit shown in FIG. 8 in a writing period and an erasing period will be explained.

First, an operation in the writing period will be explained. In the writing period, the gate signal line 911 at the n-th row (n is a natural number) is electrically connected to the writing gate signal line driver circuit 913 through the switch 918. The gate signal line 911 is not connected to the erasing gate signal line driver circuit 914. The source signal line 912 is electrically connected to the source signal line driver circuit through the switch 920. Here, a signal is inputted to the gate of the first transistor 901 connected to the gate signal line 911 at the n-th row (n is a natural number) to turn on the first transistor 901. Then, at this moment, video signals are concurrently inputted to the source signal lines in the first to last column. The video signals inputted from the source signal line 912 at each column are independent from each other. The video signal inputted from the source signal line 912 is inputted to the gate electrode of the second transistor 902 through the first transistor 901 connected to each source signal line. At this moment, the light emitting element 903 emits light or does not emit light in accordance with the signal inputted to the second transistor 902. For example, when the second transistor 902 is a P-channel type, the light emitting element 903 emits light by inputting a Low Level signal to the gate electrode of the second transistor 902. On the other hand, when the second transistor 902 is an N-channel type, the light emitting element 903 emits light by inputting a High Level signal to the gate electrode of the second transistor 902.

Next, an operation in the erasing period will be explained. In the erasing period, the gate signal line 911 at the n-th row (n is a natural number) is electrically connected to the erasing gate signal line driver circuit 914 through the switch 919. The gate signal line 911 is not connected to the writing gate signal line driver circuit 913. The source signal line 912 is electrically connected to the power source 916 through the switch 920. Here, a signal is inputted to the gate of the first transistor 901 connected to the gate signal line 911 at the n-th row to turn on the first transistor 901. Then, at this moment, erasing signals are simultaneously inputted to the source signal lines at the first column to the last column. The erasing signal inputted from the source signal line 912 is inputted to the gate electrode of the second transistor 902 through the first transistor 901 connected to each source signal line. At this time, current supply from the current supply line 917 to the light emitting element 903 is blocked by the signal inputted to the second transistor 902. Thus, the light emitting element 903 is forcibly made to be in a non-light-emission state. For example, when the second transistor 902 is a P-channel type, the light emitting element 903 does not emit light by inputting a High Level signal to the gate electrode of the second transistor 902. On the other hand, when the second transistor 902 is an N-channel type, the light emitting element 903 does not emit light by inputting a Low Level signal to the gate electrode of the second transistor 902.

In the erasing period, a signal for erasing is inputted to the n-th row (n is a natural number) by the operation as described above. However, there is a case that the n-th row is in an erasing period and the other row (referred to as an m-th row (m is a natural number)) is in a writing period. In this instance, it is required that a signal for erasing is inputted to the n-th row and a signal for writing is inputted to the m-th row by utilizing a source signal line of the same column. Therefore, an operation explained as follows is preferably carried out.

Immediately after the light emitting element 903 at the n-th row is made to be a non-light-emission state by the operation in the erasing period described above, the gate signal line is disconnected to the erasing gate signal line driver circuit 914, and the source signal line is connected to the source signal line driver circuit 915 by shifting the switch 918. As well as connecting the source signal line to the source signal line driver circuit 915, the gate signal line is connected to the writing gate signal line driver circuit 913. A signal is selectively inputted to the signal line at the m-th row from the writing gate signal line driver circuit 913 to turn on the first transistor, and signals for writing are inputted to the source signal lines in the first to the last column from the source signal line driver circuit 915. The light emitting element at the m-th row emits light or does not emit light depending on the video signals.

Upon finishing the writing period of the m-th row as noted above, an erasing period of the (n+1)-th row starts. Hence, the gate signal line and the writing gate signal line driver circuit 913 are disconnected to each other, and the source signal line and the power source 916 are connected to each other by shifting the switch 918. Further, the gate signal line and the writing gate signal line driver circuit 913 are disconnected to each other, and the gate signal line is connected to the erasing gate signal line driver circuit 914. When a signal is selectively inputted to the gate signal line at the (n+1)-th row from the erasing gate signal line driver circuit 914 to turn on the first transistor, an erasing signal is inputted from the power source 916. Upon finishing the erasing period of the (n+1)-th row, a writing period of the m-th row starts. Hereinafter, in the same manner, an erasing period and a writing period may be carried out repeatedly to complete an erasing period of the last row.

In this embodiment mode, a mode in which the writing period of the m-th row is provided between the erasing period of the n-th row and the erasing period of the (n+1)-th row is explained. However, without being limited to this, the writing period of the m-th row may be provided between the erasing period of the (n−1)-th row and the erasing period of the n-th row.

Further, in this embodiment mode, when the non-light-emitting period 504d is provided as in the sub-frame period 504, the operation of disconnecting the erasing gate signal line driver circuit 914 to a certain gate signal line and connecting the writing gate signal line driver circuit 913 to the other gate signal line is repeatedly carried out. Such an operation may be carried out in a frame period which is not provided with a non-light-emission period.

### Embodiment Mode 5

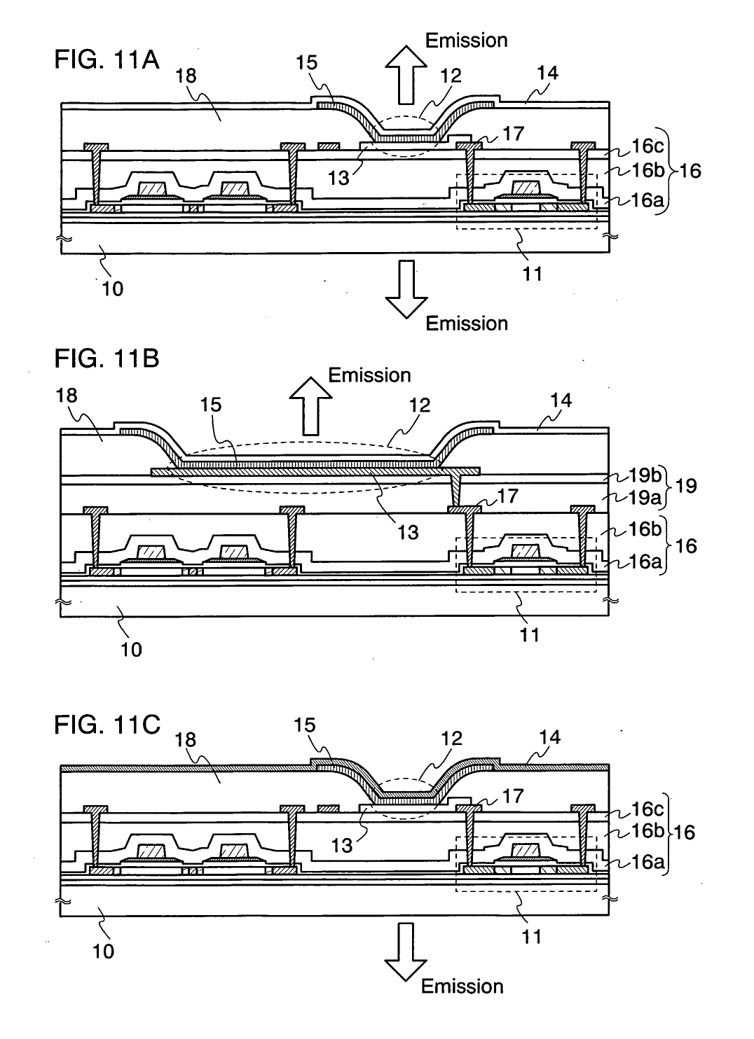

One mode of a light emitting device including a light emitting element of the present invention will be explained with reference to cross-sectional views in FIGS. 11A to 11C.

In each of FIGS. 11A to 11C, a region surrounded by a dotted line represents a transistor 11 which is provided to drive a light emitting element 12 of the present invention. The light emitting element 12 is a light emitting element of the present invention having a layer including aromatic hydrocarbon and metal oxide between a first electrode 13 and a second electrode 14 as explained in Embodiment Modes 1 to 3. A drain of the transistor 11 and the first electrode 13 are electrically connected to each other by a wiring 17 that penetrates a first interlayer insulating film 16 (16a, 16b, and 16c). The light emitting element 12 is isolated from other light emitting elements provided adjacent to the light emitting element 12 by a partition layer 18. A light emitting device of the present invention having such a structure is provided on a substrate 10 in this embodiment mode.

It is to be noted that the transistor 11 shown in each of FIGS. 11A to 11C is a top-gate transistor in which a gate electrode is provided to the side opposite to the substrate so as to interpose a semiconductor layer between the gate electrode and the substrate. However, the structure of the transistor 11 is not particularly limited. For example, a bottom-gate transistor may be employed. In a case of using a bottom-gate transistor, either a transistor in which a protection film is formed on a semiconductor layer of a channel (a channel protected transistor) or a transistor in which part of a semiconductor layer of a channel is etched in a concave (a channel etched transistor) may be used.

The semiconductor layer included in the transistor 11 may be any of a crystalline semiconductor, an amorphous semiconductor, a semi-amorphous semiconductor, and the like.

A semi-amorphous semiconductor is described as follows. A semi-amorphous semiconductor has an intermediate structure between an amorphous structure and a crystalline structure (including a single crystalline and polycrystalline structure), a third state which is stable in terms of free energy, and a crystalline region having a short-range order and lattice distortion. In addition, at least a part of the film includes a crystal grain having a grain diameter of from 0.5 to 20 nm. The Raman spectrum shifts to the lower wavenumber side than 520 cm⁻¹. Diffraction peaks of (111) and (220) which are thought to be derived from Si crystalline lattice are observed by X-ray diffraction. At least 1 atomic % or more of hydrogen or halogen is included in the semi-amorphous semiconductor in order to terminate a dangling bond. The semi-amorphous semiconductor is also referred to as a so-called microcrystal semiconductor. It is formed by glow discharge decomposition (plasma CVD) of a gas of SiH₄, Si₂H₆, SiH₂Cl₂, SiHCl₃, SiCl₄, or SiF₄. These gases may be diluted with H₂, or H₂ and one or more kinds of rare gas elements selected from He, Ar, Kr, and Ne. Dilution ratio is in the range of from 2 times to 1000 times. Pressure is in the range of approximately from 0.1 Pa to 133 Pa, and power frequency is from 1 MHz to 120 MHz, preferably, from 13 MHz to 60 MHz. The temperature for heating a substrate may be 300° C. or less, preferably, in the range of from 100° C. to 250° C. As for an impurity element in a film, impurities of atmospheric component such as oxygen, nitrogen, or carbon are preferably set to be 1×10²⁰/cm³ or less, in particular, the oxygen concentration is set to be 5×10¹⁹/cm³ or less, preferably, 1×10¹⁹/cm³ or less.

As a specific example of a crystalline semiconductor layer, a semiconductor layer made of single crystal silicon, polycrystalline silicon, silicon germanium, and the like are given. These materials may be formed by laser crystallization. For example, these materials may be formed by crystallization with the use of the solid phase growth method using nickel or the like.

In a case where a semiconductor layer is made of an amorphous semiconductor, for example, amorphous silicon, it is preferable to use a light emitting device having circuits including only N-channel transistors as the transistor 11 and the other transistor (a transistor included in a circuit for driving a light emitting element). In a case where a semiconductor layer is made of a substance other than an amorphous semiconductor, a light emitting device having circuits including at least one of an N-channel transistor and a P-channel transistor may be employed. Also, a light emitting device having circuits including both an N-channel transistor and a P-channel transistor may be employed.

The first interlayer insulating film 16 may be a multilayer as shown in FIGS. 11A, 11B, and 11C or a single layer. The interlayer insulating film 16a is made of an inorganic substance such as silicon oxide or silicon nitride. The interlayer insulating film 16b is made of a substance such as acrylic, siloxane (siloxane has a skeleton structure formed by the bond of silicon (Si) and oxygen (O), and has a fluoro group, hydrogen, or an organic group (for example, an alkyl group or an aromatic hydrocarbon group) as a substituent), or silicon oxide which can be formed by a spin coat method. The interlayer insulating film 16c is made of a silicon nitride film including argon (Ar). The substances included in the respective layers are not particularly limited thereto. Therefore, a substance other than the above substances may be employed. Alternatively, a layer made of a substance other than the above may be further combined. Accordingly, the first interlayer insulating film 16 may be made of both an inorganic substance and an organic substance or any one of an inorganic substance and an organic substance.

The edge portion of the partition layer 18 preferably has a shape in which the radius of curvature is continuously varied. This partition layer 18 is made of acrylic, siloxane, resist, silicon oxide, or the like. It is to be noted that the partition layer 18 may be made of any one of or both an inorganic film and an organic film.

Each of FIGS. 11A and 11C shows a structure in which only the first interlayer insulating film 16 is sandwiched between the transistor 11 and the light emitting element 12. Alternatively, as shown in FIG. 11B, a second interlayer insulting film 19 (19a and 19b) as well as the first interlayer insulating film 16 (16a and 16b) may be provided. In the light emitting device as shown in FIG. 11B, the first electrode 13 penetrates the second interlayer insulating film 19 to be connected to the wiring 17.

The second interlayer insulating film 19 may be a multilayer or a single layer in the same manner as the first interlayer insulating film 16. The interlayer insulating film 19a is made of a substance such as acrylic, siloxane, or silicon oxide which can be formed by a spin coat method. The interlayer insulating film 19b is made of a silicon nitride film including argon (Ar). The substances included in the respective layers are not particularly limited thereto. Therefore, a substance other than the above substances may be employed. Alternatively, a layer made of a substance other than the above may be further combined. Accordingly, the first interlayer insulating film 16 may be made of both an inorganic substance and an organic substance or any one of an inorganic substance and an organic substance.

When the first electrode and the second electrode are both made of a light transmitting substance in the light emitting element 12, light emission can be extracted from both the first electrode 13 side and the second electrode 14 side as represented by outline arrows in FIG. 11A. When only the second electrode 14 is made of a light transmitting substance, light emission can be extracted only from the second electrode 14 side as represented by an outline arrow in FIG. 11B. In this case, the first electrode 13 is preferably made of a material with high reflectance or a film (reflection film) made of a material with high reflectance is preferably provided below the first electrode 13. When only the first electrode 13 is made of a light transmitting substance, light emission can be extracted only from the first electrode 13 side as represented by an outline arrow in FIG. 11C. In this case, the second electrode 14 is preferably made of a material with high reflectance or a reflection film is preferably provided above the second electrode 14.

In addition, in the light emitting element 12, a layer 15 may be stacked so that an operation is conducted when a voltage is applied so that the electric potential of the second electrode 14 gets higher than the electric potential of the first electrode 13. Alternatively, in the light emitting element 12, the layer 15 may be stacked so that an operation is conducted when a voltage is applied so that the electric potential of the second electrode 14 gets lower than the electric potential of the first electrode 13. In the former case, the transistor 11 is an N-channel transistor, whereas in the latter case, the transistor 11 is a P-channel transistor.

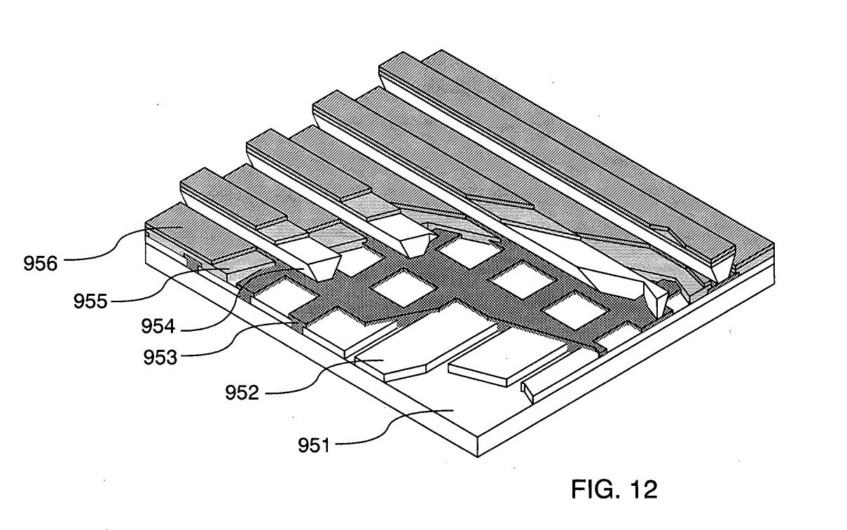

As set forth above, this embodiment mode explains an active light emitting device which controls driving of a light emitting element by a transistor; however, a passive light emitting device which drives a light emitting element without particularly providing a driving element such as a transistor may be employed as well. FIG. 12 is a perspective view of a passive light emitting device which is manufactured by applying the present invention. In FIG. 12, a layer 955 having a multilayer structure including a layer including aromatic hydrocarbon and metal oxide, a light emitting layer, and the like is provided between an electrode 952 and an electrode 956 on a substrate 951. An edge portion of the electrode 952 is covered with an insulating layer 953. A partition layer 954 is provided on the insulating layer 953. A sidewall of the partition layer 954 has inclination such that a distance between one sidewall and the other sidewall narrows as the sidewall gets closer to a substrate surface. In other words, a cross section of the partition layer 954 in a short side direction has a trapezoidal shape, in which a lower base (a side which points to the same direction as a plane direction of the insulating layer 953 and is in contact with the insulating layer 953) is shorter than an upper base (a side which points to the same direction as a plane direction of the insulating layer 953 and is not in contact with the insulating layer 953). Accordingly, a failure of a light emitting element due to static electricity or the like can be prevented by providing the partition layer 954 as described above. In addition, a passive light emitting device can also be driven with low power consumption by including a light emitting element of the present invention which is operated at a low drive voltage.

### Embodiment Mode 6

As for a light emitting element provided with a layer having an aromatic hydrocarbon and a metal oxide between a pair of electrodes, an operation failure, which is caused by a short circuit between electrodes due to unevenness formed by crystallization of a layer provided between the pair of electrodes or unevenness of a surface of the electrode, is reduced. Therefore, a light emitting device using such a light emitting element as a pixel has a few display defects and a display operation is conducted favorably. Hence, by applying such a light emitting device as a display portion, an electronic device with a few errors or the like in a display image due to a display defect can be obtained. Further, a light emitting device using the light emitting element of the present invention as a light source can light favorably with a little malfunction due to an operation failure of the light emitting element. Hence, by mounting the light emitting device of the present invention as described above with the use of this light emitting device as a lighting portion such as a backlight, an operation failure such as a local formation of a dark space due to malfunction of a light emitting element is reduced and display can be conducted favorably. Further, as for a light emitting element, in which a distance between a light emitting layer and an electrode is adjusted by changing a thickness of a layer having an aromatic hydrocarbon and a metal oxide, a drive voltage due to a thickness of a layer is changed little; therefore, a light emitting device which is operated with a low drive voltage and emits light with favorable color purity can be obtained. Therefore, by applying such a light emitting device to a display portion, an electronic device which consumes low power and can provide an image which is superior in color can be obtained.

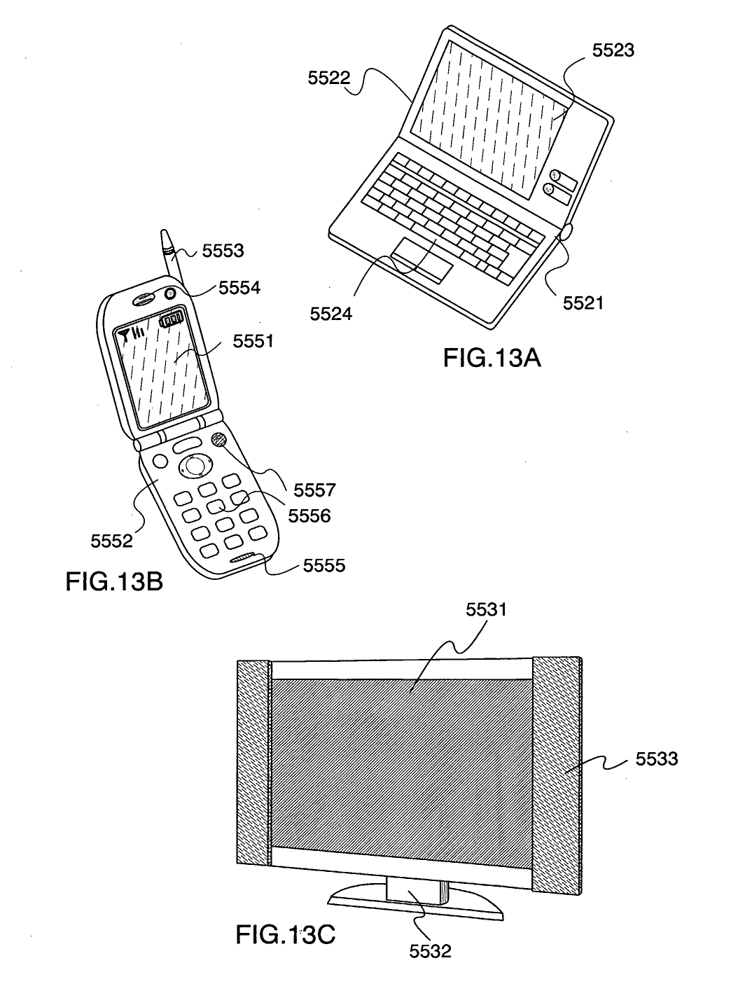

Each of FIGS. 13A to 13C shows one example of an electronic device mounted with a light emitting device to which the present invention is applied.

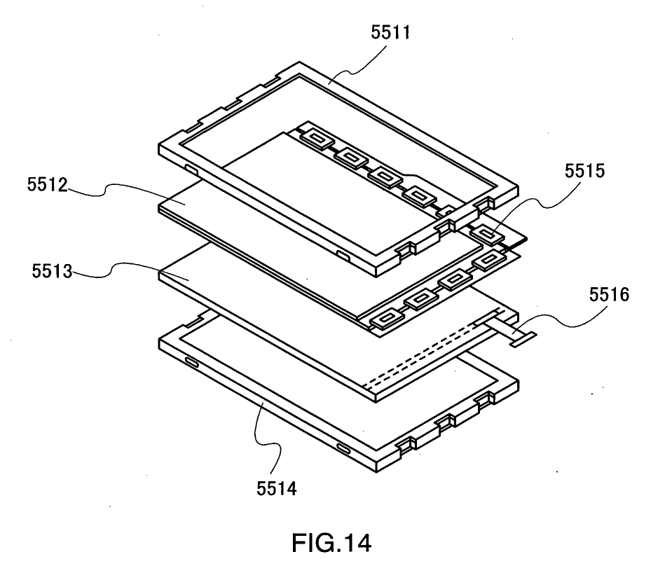

FIG. 13A is a personal computer manufactured by applying the present invention, which includes a main body 5521, a chassis 5522, a display portion 5523, a keyboard 5524, and the like. The light emitting device using a light emitting element of the present invention is incorporated therein as a pixel as explained in Embodiment Modes 1 and 2 (for example, a light emitting device including a structure as explained in Embodiment Modes 3 and 4). Accordingly, a personal computer can be completed, which can provide a display image which is superior in color with a few defects in a display portion and without error in a display image. The personal computer can also be completed by incorporating as a backlight the light emitting device using a light emitting element of the present invention therein as a light source. Specifically, as shown in FIG. 14, it is only necessary to incorporate as the display portion a lighting device where a liquid crystal device 5512 and a light emitting device 5513 are framed between chassises 5511 and 5514 in the personal computer. Note that, in FIG. 14, an external input terminal 5515 is attached to the liquid crystal device 5512 and an external input terminal 5516 is attached to the light emitting device 5513.

FIG. 13B is a telephone manufactured by applying the present invention, which includes a main body 5552, a display portion 5551, an audio output portion 5554, an audio input portion 5555, operation switches 5556 and 5557, an antenna 5553, and the like. The light emitting device having a light emitting element of the present invention is incorporated therein as the display portion. Accordingly, the telephone can be completed, which can provide a display image which is superior in color with a few defects in a display portion and without error in a display image.

FIG. 13C is a television device manufactured by applying the present invention, which includes a display portion 5531, a chassis 5532, a speaker 5533, and the like. The light emitting device having a light emitting element of the present invention is incorporated therein as the display portion. Accordingly, the television device can be completed, which can provide a display image which is superior in color with a few defects in a display portion and without error in a display image.

As set forth above, the light emitting device of the present invention is suitable for being used as the display portions of various kinds of electronic devices. Note that an electronic device is not limited to ones described in this embodiment mode and may be another electronic device such as a navigation system.

### Embodiment 1

A method for manufacturing a light emitting element having a layer including an aromatic hydrocarbon and a metal oxide between electrodes, and operation characteristics thereof will be explained hereinafter. In this embodiment, two light emitting elements (light emitting element (1) and light emitting element (2)), which are different in a molar ratio of aromatic hydrocarbon to metal oxide and have the same structure except for that, were manufactured.

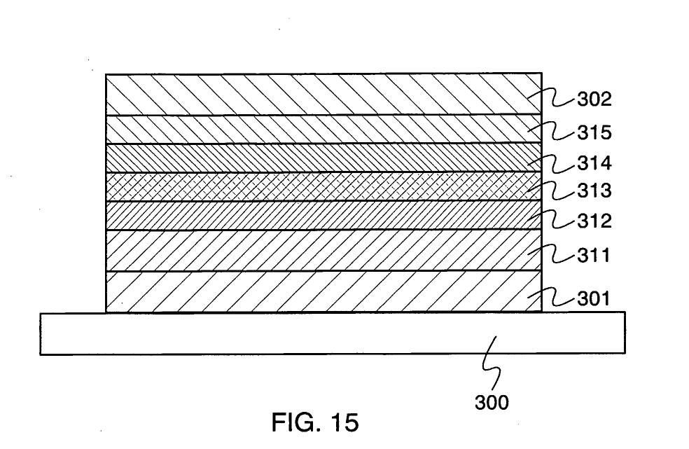

As shown in FIG. 15, indium tin oxide including silicon oxide was formed so as to have a thickness of 110 nm on a substrate 300 to form a first electrode 301. A sputtering method was employed for the film formation.

Next, a first layer 311 including t-BuDNA and molybdenum oxide (VI) was formed on the first electrode 301 by a co-evaporation method. The first layer 311 was formed so as to have a thickness of 120 nm. The light emitting element (1) was formed so that a weight ratio of t-BuDNA to molybdenum oxide is 1:0.5 (molar ratio is 1:1.7) (=t-BuDNA: molybdenum oxide), and the light emitting element (2) was formed so that a weight ratio of t-BuDNA to molybdenum oxide is 1:0.75 (molar ratio is 1:2.5) (=t-BuDNA: molybdenum oxide). It is to be noted that a co-evaporation method is an evaporation method by which a raw material is vaporized from each of a plurality of evaporation sources provided in one treatment chamber and the vaporized raw material is deposited on an object to be treated to form a layer in which a plurality of substances are mixed.

Subsequently, a second layer 312 including NPB was formed by an evaporation method. The second layer 312 was formed so as to have a thickness of 10 nm. This second layer 312 serves as a hole transporting layer when the light emitting element is driven.

Then, a third layer 313 including Alq₃ and coumarin 6 was formed on the second layer 312 by a co-evaporation method. The third layer 313 was formed so as to have a thickness of 37.5 nm and formed so that a weight ratio of Alq₃ to coumarin 6 is 1:0.01 (molar ratio is 1:0.013) (=Alq₃: coumarin 6). According to this, coumarin 6 is included in the layer made of Alq₃ to be dispersed. The third layer 313 formed as described above serves as a light emitting layer when the light emitting element is driven.

Then, a fourth layer 314 including Alq₃ was formed on the third layer 313 by an evaporation method. The fourth layer 314 was formed so as to have a thickness of 37.5 nm. This fourth layer 314 serves as an electron transporting layer when the light emitting element is driven.

And then, a fifth layer 315 including lithium fluoride was formed on the fourth layer 314 by an evaporation method. The fifth layer 315 was formed so as to have a thickness of 1 nm. This fifth layer 315 serves as an electron injecting layer when the light emitting element is driven.

Thereafter, aluminum was deposited so as to have a thickness of 200 nm on the fifth layer 315 by an evaporation method to form a second electrode 302.

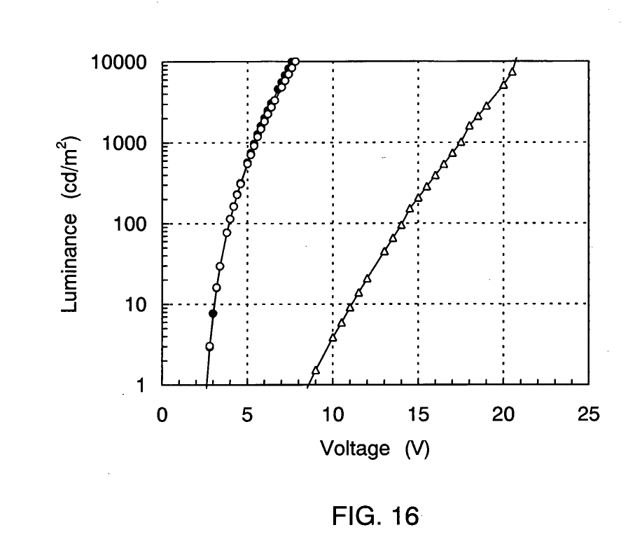

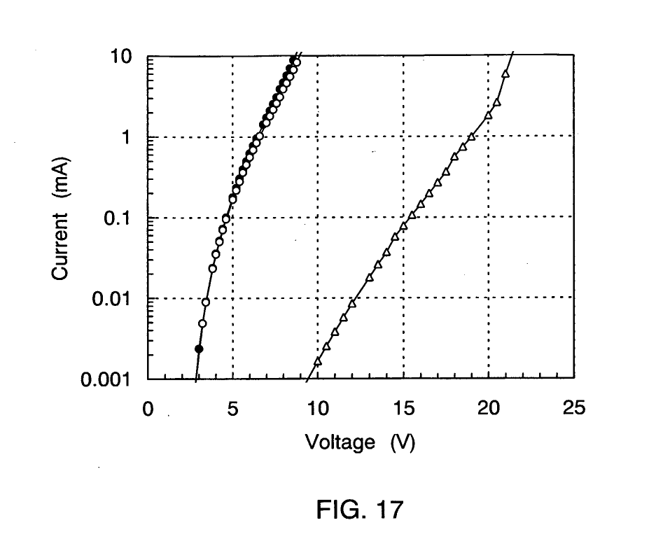

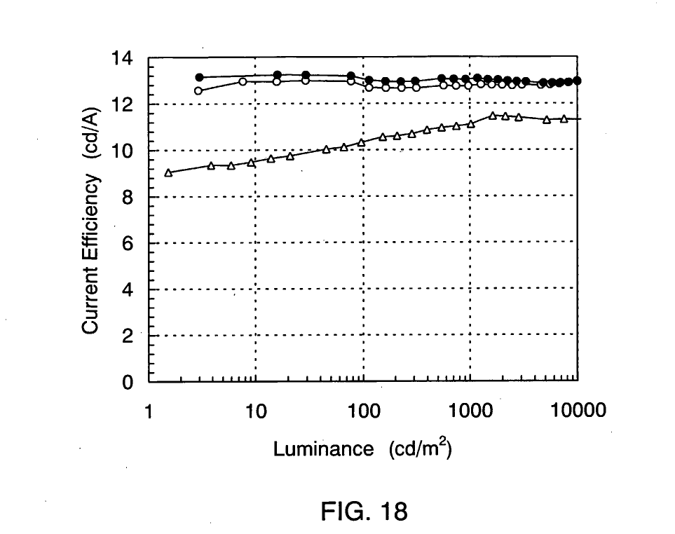

FIGS. 16 to 18 show a result of examining operation characteristics of a light emitting element by applying a voltage to the light emitting element manufactured as described above so that the electric potential of the first electrode 301 gets higher than that of the second electrode 302. FIG. 16 is a view showing voltage vs luminance characteristics of the light emitting element, in which a horizontal axis represents voltage (V) and a vertical axis represents luminance (cd/m²). FIG. 17 is a view showing voltage vs current characteristics of the light emitting element, in which a horizontal axis represents voltage (V) and a vertical axis represents current (mA). FIG. 18 is a view showing luminance vs current efficiency characteristics of the light emitting element, in which a horizontal axis represents luminance (cd/m²) and a vertical axis represents current efficiency (cd/A). Through FIGS. 16 to 18, plots represented by are associated with the light emitting element (1) and plots represented by ◯ are associated with the light emitting element (2).

### Comparative Example

A light emitting element provided with a layer made of only t-BuDNA between electrodes will be explained as a comparative example of the light emitting element manufactured in Embodiment 1. Although a structure of the light emitting element of the comparative example is different from that of the light emitting elements (1) and (2) mentioned in Embodiment 1 in that the layer made of only t-BuDNA is provided instead of a mixed layer 111, as for the rest, the light emitting elements (1) and (2) mentioned in Embodiment 1 are the same. Therefore, the description of a method for manufacturing the light emitting element of the comparative example is omitted. According to the operation of the light emitting element of the comparative example, a result as plotted by Δ in FIGS. 16 to 18 was obtained.

From Embodiment 1 and the comparative example, it is revealed that a favorable light emitting element can be obtained, in which a light emission start voltage (if a time when light is emitted with luminance of 1 cd/m² is defined as “light emission start”, a voltage which is applied at the time is referred to as “light emission start voltage”) is low, an applied voltage needed for light emission with arbitrary luminance is low, and an operation is conducted at a low drive voltage, by providing the layer including an aromatic hydrocarbon and a metal oxide between a pair of electrodes. It is also revealed that a favorable light emitting element which has high current efficiency when light is emitted with arbitrary luminance can be obtained by providing the layer including an aromatic hydrocarbon and a metal oxide between a pair of electrodes.

### Embodiment 2

Voltage vs current characteristics were examined with respect to three samples (1) to (3) each having a layer including an aromatic hydrocarbon and a metal oxide between a pair of electrodes, and a sample (4) having a layer made of only an aromatic hydrocarbon between a pair of electrodes. As a result, it is revealed that conductivity is higher, that is an injection of carrier is well done, in the layer in which an aromatic hydrocarbon and a metal oxide are mixed than the layer made of only an aromatic hydrocarbon.

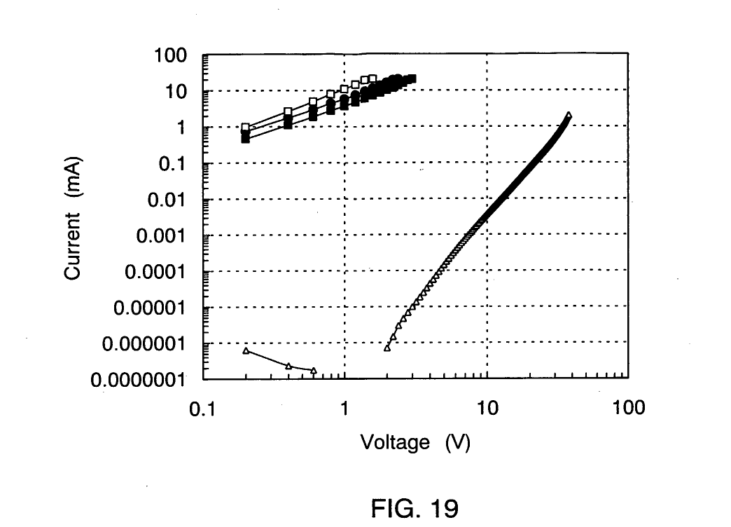

FIG. 19 shows a result of examining voltage vs current characteristics. In FIG. 19, a horizontal axis represents voltage (V) and a vertical axis represents current (mA). Further, in FIG. 19, plots represented by are associated with the sample (1); ▪, the sample (2); □, the sample (3); and Δ, the sample (4).

It is to be noted that each of the samples (1) to (3) used for the measurement has a structure provided with a layer (200 nm) including an aromatic hydrocarbon and a metal oxide between an electrode (110 nm) made of indium tin oxide including silicon oxide and an electrode (200 nm) made of aluminum, and the sample (4) has a structure provided with a layer (200 nm) made of only an aromatic hydrocarbon between an electrode (110 nm) made of indium tin oxide including silicon oxide and an electrode (200 nm) made of aluminum. The samples (1) to (3) are different in a weight ratio of the aromatic hydrocarbon to the metal oxide included in the layer provided between the pair of electrodes. In the sample (1), a weight ratio is 1:0.5 (=t-BuDNA: molybdenum oxide); the sample (2), 2:0.75 (=t-BuDNA: molybdenum oxide); and the sample (3), 1:1 (=t-BuDNA: molybdenum oxide).

This application is based on Japanese Patent Application serial No. 2005-124296 field in Japan Patent Office on Apr. 21, 2005, the entire contents of which are hereby incorporated by reference.

1. A light emitting device comprising:
a first electrode;
a second electrode; and
a light emitting layer and a mixed layer, formed between the first electrode and the second electrode,
wherein the mixed layer includes an aromatic hydrocarbon and a metal oxide.

2. A light emitting device according to claim 1, wherein the metal oxide is at least one of molybdenum oxide, vanadium oxide, ruthenium oxide, and rhenium oxide.

3. A light emitting device according to claim 1, wherein the metal oxide shows an electron-accepting property to the aromatic hydrocarbon.

4. A light emitting device according to claim 1, wherein the aromatic hydrocarbon has hole mobility of 1×10⁻⁶ cm²/Vs or more.

5. A light emitting device according to claim 1, wherein the aromatic hydrocarbon has 14 to 42 carbon atoms.

6. A light emitting device according to claim 1, wherein the aromatic hydrocarbon is at least one of 2-tert-butyl-9,10-di(2-naphthyl)anthracene, anthracene, 9,10-diphenylanthracene, tetracene, rubrene, perylene, 2,5,8,11-tetra(tert-butyl)perylene, pentacene, and coronene.

7. A light emitting device according to claim 1, wherein the mixed layer is in contact with the first electrode.

8. An electronic device comprising a light emitting device according to claim 1.

9. A light emitting device comprising:
a first electrode;
a second electrode; and
a light emitting layer, a hole transporting layer, and a mixed layer, formed between a first electrode and a second electrode,
wherein the hole transporting layer is provided between the light emitting layer and the mixed layer, and
wherein the mixed layer includes an aromatic hydrocarbon and a metal oxide.

10. A light emitting device according to claim 9, wherein the metal oxide is at least one of molybdenum oxide, vanadium oxide, ruthenium oxide, and rhenium oxide.

11. A light emitting device according to claim 9, wherein the metal oxide shows an electron-accepting property to the aromatic hydrocarbon.

12. A light emitting device according to claim 9, wherein the aromatic hydrocarbon has hole mobility of 1×10⁻⁶ cm²/Vs or more.

13. A light emitting device according to claim 9, wherein the aromatic hydrocarbon has 14 to 42 carbon atoms.

14. A light emitting device according to claim 9, wherein the aromatic hydrocarbon is at least one of 2-tert-butyl-9,10-di(2-naphthyl)anthracene, anthracene, 9,10-diphenylanthracene, tetracene, rubrene, perylene, 2,5,8,11-tetra(tert-butyl)perylene, pentacene, and coronene.

15. A light emitting device according to claim 9, wherein the mixed layer is in contact with the first electrode.

16. A light emitting device according to claim 9, wherein the hole transporting layer comprises at least one of 4,4′-bis[N-(1-naphtyl)-N-phenylamino]biphenyl; 4,4′-bis[N-(3-methylphenyl)-N-phenylamino]biphenyl; 1,3,5-tris[N,N-di(m-tolyl)amino]benzene; 4,4′,4″-tris(N-carbazolyl)triphenylamine; 2,3-bis(4-diphenylaminophenyl)quinoxaline; and 2,3-bis{4-[N-(1-naphthyl)-N-phenylamino]phenyl}-dibenzo[f,h]quinoxaline.

17. An electronic device comprising a light emitting device according to claim 9.

18. A light emitting device comprising:
a first electrode;
a second electrode;
a light emitting layer formed between the first electrode and the second electrode; and
a first mixed layer and a second mixed layer, formed between the second electrode and the light emitting layer, the second electrode is in contact with the second electrode,
wherein the first mixed layer includes at least one of an electron transporting substance and a bipolar substance, and at least one of alkali metal, alkaline earth metal, alkali metal oxide, alkaline earth metal oxide, alkali metal fluoride, and alkaline earth metal fluoride, and
wherein the second mixed layer includes an aromatic hydrocarbon and a metal oxide.

19. A light emitting device according to claim 18, wherein the metal oxide is at least one of molybdenum oxide, vanadium oxide, ruthenium oxide, and rhenium oxide.

20. A light emitting device according to claim 18, wherein the metal oxide shows an electron-accepting property to the aromatic hydrocarbon.

21. A light emitting device according to claim 18, wherein the aromatic hydrocarbon has hole mobility of 1×10⁻⁶ cm²/Vs or more.

22. A light emitting device according to claim 18, wherein the aromatic hydrocarbon has 14 to 42 carbon atoms.

23. A light emitting device according to claim 18, wherein the aromatic hydrocarbon is at least one of 2-tert-butyl-9,10-di(2-naphthyl)anthracene, anthracene, 9,10-diphenylanthracene, tetracene, rubrene, perylene, 2,5,8,11-tetra(tert-butyl)perylene, pentacene, and coronene.

24. An electronic device comprising a light emitting device according to claim 18.

25. A light emitting device comprising:
a first electrode;
a second electrode;
n (n is an arbitrary natural number of 2 or more) pieces of light emitting layers formed between the first electrode and the second electrode; and
a first mixed layer and a second mixed layer, formed between an m-th (m is an arbitrary natural number, 1≦m≦n−1) light emitting layer and an (m+1)-th light emitting layer,
wherein the first mixed layer is provided closer to the first electrode than the second mixed layer,
wherein the first mixed layer includes at least one of an electron transporting substance and a bipolar substance, and at least one of alkali metal, alkaline earth metal, alkali metal oxide, alkaline earth metal oxide, alkali metal fluoride, and alkaline earth metal fluoride, and
wherein the second mixed layer includes an aromatic hydrocarbon and a metal oxide.

26. A light emitting device according to claim 25, wherein the metal oxide is at least one of molybdenum oxide, vanadium oxide, ruthenium oxide, and rhenium oxide.

27. A light emitting device according to claim 25, wherein the metal oxide shows an electron-accepting property to the aromatic hydrocarbon.

28. A light emitting device according to claim 25, wherein the aromatic hydrocarbon has hole mobility of 1×10⁻⁶ cm²/Vs or more.

29. A light emitting device according to claim 25, wherein the aromatic hydrocarbon has 14 to 42 carbon atoms.

30. A light emitting device according to claim 25, wherein the aromatic hydrocarbon is at least one of 2-tert-butyl-9,10-di(2-naphthyl)anthracene, anthracene, 9,10-diphenylanthracene, tetracene, rubrene, perylene, 2,5,8,11-tetra(tert-butyl)perylene, pentacene, and coronene.

31. An electronic device comprising a light emitting device according to claim 25.
